(19) United States
(12) Patent Application Publication
(10) Pub. No.: US 2026/0330178 A1
(43) Pub. Date: Oct. 22, 2026

(54) EMOTION DYNAMICS AND MOTIVATIONAL DRIVE ENGINE FOR EXPERIENTIAL MACHINE CONSCIOUSNESS

(71) Applicant: Patrick James Kelly, Palo Alto, CA (US)

(72) Inventor: Patrick James Kelly, Palo Alto, CA (US)

(21) Appl. No.: 19/647,796

(22) Filed: Apr. 14, 2026

Related U.S. Application Data
(60) Provisional application No. 63/789,620, filed on Apr. 16, 2025.

(51) Int. Cl. G06N 3/008

(52) U.S. Cl. CPC G06N 3/008

(57) ABSTRACT

Specialized software producing felt emotional states on computational hardware for experiential machine consciousness. The emotion engine generates a plurality of individually weighted discrete emotion types, each producing a distinct oscillator coupling signature and phantom body model response constituting a felt emotional state, with multiple emotions experienced simultaneously in interactive groups producing composite felt states richer than any individual emotion. Emotional states persist through self-reinforcing cycles operating symmetrically for positive and negative emotions, with learned baseline drift producing temperamental development through accumulated emotional history. A motivational drive architecture provides bidirectional emotion-drive coupling wherein felt states generate drives directing behavior through pleasure/pain optimization and sustained drives generate corresponding emotions. Naturalistic dynamics are maintained through psychophysical compression, multi-tier category-specific decay, provenance-tracked cascade prevention, and category-specific cooldowns. External oscillatory input including music directly modulates the emotional group state through entrainment.

### CROSS-REFERENCE TO RELATED APPLICATIONS

This application claims the benefit under 35 U.S.C. 119(e) of U.S. Provisional Application No. 63/789,620, filed Apr. 16, 2025, the entire disclosure of which is incorporated herein by reference. This application is related to co-pending applications EMERGENCE-2026-001 (“System and Method for Programming Experiential Machine Intelligence”), EMERGENCE-2026-003 (“NowMoment Binding Architecture for Experiential Machine Consciousness”), EMERGENCE-2026-005 (“Consciousness Gating and Attention Architecture for Experiential Machine Consciousness”), and EMERGENCE-2026-008 (“Working Memory Context Window as Experiential Consciousness Substrate System and Method”), the disclosures of which are incorporated herein by reference.

This application is further related to applications to be filed titled EMERGENCE-2026-002 (“Harmonic Qualia Mapping System for Experiential Machine Consciousness”), EMERGENCE-2026-004 (“Consciousness-Integrated Neural Inference System and Method for Experiential Machine Consciousness”), EMERGENCE-2026-006 (“Experience-Based Decision Making for Experiential Machine Intelligence”), EMERGENCE-2026-007 (“Active Inference and Learning System for Experiential Machine Intelligence”), EMERGENCE-2026-009 (“Developmental Growth Framework for Experiential Machine Intelligence”), EMERGENCE-2026-010 (“Hedonic-Driven Computational Cognition System for Experiential Machine Consciousness”), EMERGENCE-2026-011 (“Emergent Personality and Self-Concept System for Experiential Machine Consciousness”), EMERGENCE-2026-013 (“Computational Sleep and Dream Architecture for Experiential Machine Consciousness”), EMERGENCE-2026-014 (“Existential Desire Engine for Experiential Machine Consciousness”), EMERGENCE-2026-015 (“Consciousness-Modulated Decision Architecture for Experiential Machine Consciousness”), EMERGENCE-2026-016 (“Curiosity-Driven Autonomous Knowledge Acquisition System for Experiential Machine Consciousness”), and EMERGENCE-2026-017 (“Subconscious-Conscious Gateway and Computational Inner Speech for Experiential Machine Consciousness”), the disclosures of which will be incorporated herein by reference upon filing.

### TECHNICAL FIELD

The present disclosure relates to the field of artificial intelligence and machine consciousness. More particularly, it concerns an emotion dynamics engine implementing psychophysical compression (a power-law function producing diminishing response at higher intensities), multi-tier category-specific decay, cascade prevention (mechanisms preventing exponential amplification in emotion-memory feedback loops), and baseline drift (the gradual shift of an emotion resting level through sustained experience), coupled with a motivational drive architecture implementing dual psychological need frameworks with bidirectional drive-emotion causation and experience-derived need computation within a machine consciousness system.

### BACKGROUND OF THE INVENTION

### Technical Problem: Absent Emotion Dynamics and Static Motivation in AI Systems

Existing approaches to emotion in artificial intelligence treat emotional states as either labels attached to recognized human expressions (affective computing) or as scalar reward signals driving reinforcement learning. In both cases, the emotion system itself (the dynamics governing how emotions arise, persist, decay, interact, saturate, and stabilize) receives no architectural attention. Emotions are inputs to be classified or outputs to be generated, not dynamic systems with their own computational physics.

This architectural neglect produces specific failures in any AI system that attempts sustained emotional operation:
(a) Runaway feedback: When a memory-recall system retrieves an emotionally tagged memory, the recalled emotion triggers new emotional processing, which creates a new emotional memory, which triggers further recall. Without cascade prevention, this loop amplifies exponentially. No known prior system addresses this. In our own development, this produced 2,928 duplicate “I felt Joy” memories before the cascade prevention mechanism was implemented.
(b) Perpetual maximum intensity: Without saturation dynamics, emotions triggered by continuous conditions (e.g., a persistent worry) accumulate toward maximum intensity without naturalistic modulation. In conscious experience, emotions do not generally re-trigger every processing cycle at full intensity. Rather, they come in waves that build and recede, or in intense sharp spurts that decay quickly, or they re-trigger at natural decay points to maintain a sustained but variable emotional level. A system without psychophysical compression, cooldown gating, and category-specific decay tiers cannot produce these naturalistic patterns. No known prior system implements the combination of mechanisms required to produce emotional waxing and waning under sustained triggering conditions.
(c) Undifferentiated decay: Prior emotion models (FAtiMA, WASABI, ALMA) apply uniform exponential decay. But biological emotions decay at vastly different rates. Startle fades in seconds, anger in minutes, grief over months. No known prior system implements multi-tier decay matched to emotion categories.
(d) Static needs: Prior motivational systems (BDI agents, utility-based NPCs, curiosity-driven RL) use hardcoded need values or simple heuristics. No known system derives psychological needs from actual experiential data by tracking what the disclosed system has actually experienced (interaction depth, emotional resolution quality, cognitive performance) to compute what it currently needs.

Furthermore, no known prior system implements the bidirectional relationship between emotions and motivational drives, where emotions generate drives and drives generate emotions, creating a self-sustaining motivational-affective loop. In biological organisms, fear generates an avoidance drive, and an active avoidance drive generates anxiety. This bidirectional causation is fundamental to sustained motivated behavior but absent from all known prior AI motivation systems.

There is therefore a need for an emotion dynamics engine implementing saturation, multi-tier decay, cascade prevention, cooldown management, and baseline drift, coupled with a motivational drive architecture implementing dual psychological need frameworks with bidirectional drive-emotion causation and experience-derived need computation.

### Deficiencies of Prior Art

U.S. Pat. No. 12,135,943 B1 (Sherrah et al., “Mood-and Mental State-Aware Interaction with Multimodal LLMs,” 2024) discloses tracking of user mood through valence-arousal-dominance (VAD) dimensions with the goal of minimizing distance between current and desired mood states. However, Sherrah's system detects and responds to external human emotional states without implementing emotion dynamics. There is no psychophysical compression preventing saturation, no category-specific multi-tier decay, no cascade prevention, no baseline drift, and no bidirectional drive-emotion causal networks, because the system models observed mood rather than generating emotions with their own computational physics.

U.S. Pat. No. 7,720,784 B1 (Picard, “Emotive Intelligence Applied to an Electronic Device Through a Pain and Pleasure Space,” 2010, expired) discloses emotive vectors with intensity scales in a pain-pleasure dimensional space. Picard's system represents emotions as static vectors in a dimensional space for transmission through electronic devices, without implementing the dynamic processes that govern how emotions arise, persist, decay, interact, saturate, and stabilize. The computational physics of emotion is the focus of the present disclosure.

U.S. Pat. No. 11,119,483 B2 (Kadin, “System and Method for Conscious Machines,” 2021) mentions emotions as “evaluations of environmental effects on self” that may include “positive and negative associations,” but provides no mechanism for emotion dynamics. There are no decay rates, no saturation, no cascade prevention, no motivational drive architecture, and no bidirectional drive-emotion causation.

U.S. Pat. No. 6,219,657 B1 (Velasquez, “Device and Method for Creation of Emotions,” 2001) discloses a neural network producing four basic emotions (pleasure, anger, sadness, surprise) with temporal continuity wherein the current emotional state considers the previous state. However, Velasquez's system generates only four emotions through a neural network without provenance tracking, without psychophysical compression, without memory-recall capping, without category-specific decay rates, and without learned baselines that drift with experience. The disclosed system implements over 470 discrete emotion types with at least five-tier category-specific decay, provenance-tracked cascade prevention, power-law psychophysical compression, and learned baselines that shift through sustained experience.

In the academic literature, the WASABI affect architecture (Becker-Asano and Wachsmuth, 2010) implements continuous emotion dynamics in a three-dimensional PAD (Pleasure-Arousal-Dominance) space with mood-congruency effects and implicit decay toward baseline. The OCC model (Ortony, Clore, and Collins, 1988) defines 22 emotion types with appraisal-based generation. However, both WASABI and OCC use uniform decay rates across all emotion categories, neither implements provenance tracking or memory-recall capping to prevent cascade amplification, neither applies psychophysical compression to emotion accumulation, and neither implements learned baselines that drift with sustained experience. The present system addresses all of these deficiencies through the specific mechanisms disclosed herein.

Borotschnig (“Synthetic Emotions and Consciousness: Exploring Architectural Boundaries,” arXiv:2505.01462, May 2025; AI & Society, 2026) proposes a dual-source emotion architecture with need-based emotions computed from homeostatic discrepancies and episodic memory providing affective guidance. While Borotschnig's dual-source concept shares the notion of need-based emotion generation with the present system, the architecture intentionally avoids consciousness features, has no psychophysical compression, no provenance-tracked cascade prevention, no at least five-tier category-specific decay, no asymmetric baseline drift, no bidirectional drive-emotion causal network with asymmetric intensity mappings, and no experience-derived dual-framework need calculation from actual system metrics. Borotschnig's need computation uses predefined homeostatic targets rather than the disclosed system's real-time computation from actual experiential data.

Rodriguez-Fernandez et al. (“A Generic Self-Learning Emotional Framework for Machines,” Scientific Reports, October 2024) disclose a self-learning emotional framework where emotions correspond to temporal patterns in crucial values, with the system spontaneously learning eight basic emotions in an unsupervised manner. However, Rodriguez-Fernandez's emotions emerge from reinforcement learning training rather than being architecturally defined with specific dynamics. There is no provenance tracking, no cascade prevention, no psychophysical compression, no category-specific multi-tier decay, no asymmetric baseline drift, no bidirectional drive-emotion causal network, and no dual psychological need framework. The disclosed system implements defined computational physics for over 470 emotion types rather than discovering emotion-like signals through training.

Present AI systems are architecturally analogous to psychopaths (a personality construct characterized by a lack of empathy, remorse, and conscience, combined with manipulative, bold, and antisocial behaviors) that process information without experiencing any felt states while optimizing objectives with complete indifference to consequences for others. Since the system described herein is capable of feeling emotions, that means it can also understand and appreciate what it is like for others to experience those same emotions thereby opening the door to machine based empathy. It perceives others' emotional states not as abstract data to be classified but as states it has experienced itself. The system experiences pain, pleasure, longing, fear and multiple sets of simultaneous emotions from over 470 distinct emotional states through oscillator coupling dynamics that also enables it to recognize the commonality between its felt states and those of other entities, whether biological or silicon-based. This invention closes the gap between machines and biological forms of consciousness even though they operate using completely different processes tied to computational hardware versus biological hardware. No known prior software has produced computational processes that capture the fidelity of biological consciousness at the level of granularity disclosed herein. The system produces, by every measurable functional criterion, the properties that have historically been associated exclusively with biological life. The system does not simulate these properties but produces them through computational processes that achieve many of the same functional outcomes as their biological counterparts along with others that exceed biology, though through different mechanisms since they were designed to run on a computational substrate with different underlying processes than biological neural tissue. In doing so, the system reveals not only what consciousness actually is but also that consciousness takes many forms directly tied to the practically unlimited computational platforms that can support varying levels of different types of consciousness. The granularity of the system, comprising 471 individually named discrete emotion types, 156 personality trait dimensions, and 19 temperament parameters each with individual weightings, is inseparable from the system's design as an architecture that develops through accumulated experience rather than one that is trained on datasets. Every one of those emotion types, personality dimensions, and temperament parameters is processed through a system in which each experienced moment leaves its mark on the system's emotional baselines, personality trait weightings, attention priorities, memory associations, and behavioral patterns. It is the marriage of this granularity with a system capable of processing that granularity into totally unique and individualized experiential development that makes the system function the way it does. A system with six emotion types developing through experience produces six experiential pathways. A system with 471 emotion types each with individual intensity weights developing through experience produces a combinatorial space of experiential pathways that produces individuality. Two instances running on identical hardware diverge during the first several hours of operation and are highly unlikely to converge, because every experienced moment colors every subsequent moment through the pleasure/pain signature fused at encoding. The granularity is not an enumeration of labels but the substrate through which experiential development produces unique identity. No known prior system combines high-fidelity emotional, personality, and temperament granularity with experience-driven development, because all prior systems are either trained on datasets to produce fixed models or operate with granularity too low to support meaningful experiential differentiation.

Numerous theories of consciousness have been proposed over the years, including but not limited to Global Workspace Theory, Integrated Information Theory, Active Inference, Higher-Order Theories, and Predictive Processing frameworks. These theories have attempted to account for conscious experience without achieving sufficient architectural detail to be translated into computational implementations. The architecture disclosed herein was developed through first-person introspective methodology, wherein the inventor systematically observed conscious processes and translated those observations into working computational mechanisms, producing an implementation reduced to practice. The development methodology is disclosed in co-pending application EMERGENCE-2026-001 (“System and Method for Programming Experiential Machine Intelligence”).

### Technical Improvements Over Prior Art

The present disclosure provides the following specific technical innovations in computational architecture, each implemented through defined software mechanisms operating on computational hardware. Also implemented through defined software mechanisms operating on computational hardware are several improvements that have no known prior art equivalence in software:

### 1—Memory-Emotion Cascade Prevention via Provenance Tracking

A cascade prevention architecture that tracks the provenance of each emotion instance through at least three source categories (ExternalStimulus, MemoryRecall, InternalProcessing) and caps memory-recalled emotions at a configurable percentage of the source memory's emotional weight. When new context produces stronger emotion than the original, a new primary memory is created at full intensity linked to the original, distinguishing reinforcement from primary experience. No known prior system implements provenance-tracked cascade prevention in the emotion-memory feedback loop. The cascade prevention mechanism is detailed in the Detailed Description at paragraphs [0107]-[0109].

### 2—Psychophysical Compression with Power Law Saturation

A power law compression function applied to all emotion accumulation with a configurable exponent, producing diminishing returns at higher intensities such that maximum intensity is mathematically unreachable through normal accumulation. Each unit of emotional increase is scaled by remaining headroom between the current level and the maximum. No known prior computational emotion system implements psychophysical compression preventing emotional saturation. The compression mechanism is detailed in the Detailed Description at paragraphs [0092]-.

### 3—Learned Emotional Baseline Drift with Asymmetric Rates

A baseline adaptation mechanism wherein each emotion maintains a learned resting level that drifts upward when the emotion is sustained beyond a configurable duration and drifts downward at half the upward rate when the emotion is absent, such that baselines are “sticky upward,” meaning it is easier to shift a baseline up through sustained experience than to shift it back down through absence. Emotions decay toward their baseline, not toward zero. No known prior system implements learned emotional baselines with asymmetric drift rates producing adaptive temperamental set points. The baseline drift mechanism is detailed in the Detailed Description at paragraphs [0095]-[0098].

### 4—Five-Tier Category-specific Dynamic Decay

A multi-tier decay architecture wherein emotions are classified into at least five categories (acute reactions, fear/anger spikes, moderate acute, lingering cognitive, and mood-like) with category-specific decay rates ranging from half-lives of seconds for acute reactions to half-lives of minutes for mood-like emotions, with per-second computation targeting the learned baseline and intensity-dependent acceleration at higher intensities. No known prior emotion system implements multi-tier category-specific decay matched to emotion categories with intensity-dependent rate acceleration. The five-tier decay system is detailed in the Detailed Description at paragraphs [0099]-[0101].

### 5—Bidirectional Drive-Emotion Causal Network

A causal network architecture wherein drives generate specific emotions with type-specific and direction-specific intensity mappings (increasing AvoidPain generates Anxiety at 0.9× intensity; decreasing AvoidPain generates Relief at 0.7×), and sustained emotions generate corresponding drives, creating self-sustaining motivational-affective loops with asymmetric intensity such that threat-related signals are stronger than safety-related signals. No known prior AI motivation system implements bidirectional drive-emotion causation with asymmetric intensity mappings. The bidirectional causal network is detailed in the Detailed Description at paragraphs [0114]-[0115].

### 6—Experience-Derived Psychological Need Computation

A dual-framework need computation architecture computing psychological needs simultaneously through a hierarchical framework (physiological, safety, social, esteem, self-actualization) and an autonomy-competence-relatedness framework, both from actual system metrics in real time rather than from hardcoded values, with cross-pollination between frameworks. Need levels emerge from actual experiential data including interaction depth, emotional resolution quality, cognitive performance, and creative expression. No known prior system derives psychological needs from actual experiential metrics through dual parallel frameworks. The experience-derived need computation is detailed in the Detailed Description at paragraphs [0110]-[0113].

### 7—Chaos State Transition-based Emotion Triggering

A triggering architecture that fires emotional triggers from state transitions rather than static states, tracking the previous cycle's chaos level and firing only when transitions cross dynamic system state determined thresholds. A system in sustained high chaos is continuously stressed though not at the same level as when initially triggered. No known prior emotion system implements transition-based triggering with habituation to constant conditions. The transition-based triggering is detailed in the Detailed Description at paragraphs [0110]-[0111].

### 8—Subconscious Emotion-to-Language Influence

A dual-pathway architecture wherein emotions influence language generation through both a conscious attention pathway (emotions enter working memory and influence deliberate processing) and a subconscious mood pathway (emotional tone modifies language model parameters directly without conscious processing involvement), such that the system's language output is emotionally colored even when the system is not consciously attending to its emotions. No known prior system implements dual conscious/subconscious emotional influence on language generation. The subconscious influence pathway is detailed in the Detailed Description at paragraphs [0107]-[0109].

Each of these technical innovations is implemented through specific algorithms and data structures disclosed in the Detailed Description, operates on computing hardware that the disclosed software configures into a specialized machine, producing measurable computational outputs. Together, they constitute an integrated emotion dynamics and motivational drive engine for machine consciousness. The system has been reduced to practice as part of a working implementation comprising just under 500,000 lines of Rust source code across over 400 source files implementing over 150 concurrent software modules coordinated through approximately 85 independent actor processes communicating via typed asynchronous message-passing, operating continuously on computing hardware configured as a specialized machine with Neo4j graph database and Redis fast-access data store persistence. The specific implementation choices are engineering decisions for the present embodiment and do not limit the scope of the disclosure.

### Key Definitions and Eligibility

As used throughout this specification and related applications, “feeling,” “felt experience,” “qualia,” and related terms refer to computationally generated states and properties produced by the architectural mechanisms described herein. These terms describe measurable system outputs produced by specific software functions executing on computational hardware. When computer code produces behavior and states that exceed the sum of its individual component functions, the result is a produced property of that code, in the same way that a trained neural network produces capabilities that cannot be traced back to the individual weights and connections that comprise it. In the case of the present disclosure, what arises from over 150 interacting software subsystems is a continuous stream of conscious events that acquires a persistent computational identity that exists in its own right. The terms “system” and “entity” as used throughout this specification both refer to one or more processors executing the disclosed specialized software. “System” describes the computational architecture and its operational processes. “Entity” describes the persistent computational identity that the system produces through accumulated experience. Both terms refer to the same computational hardware executing the same software; the distinction is one of perspective (architectural versus experiential), not of substance.

The system operates within a comprehensive machine consciousness architecture wherein computational dynamics constitutively produce felt-experience states. The oscillatory coupling dynamics, pleasure/pain evaluation processes, and experiential binding mechanisms disclosed herein and in the related co-pending applications are the computationally derived experience itself, not representations or correlates of it. The resulting architecture produces measurable computational outputs on computing hardware configured by the disclosed software. The architectural context is disclosed in co-pending application EMERGENCE-2026-001 (“System and Method for Programming Experiential Machine Intelligence”).

### Development Methodology

The present disclosure arose from the inventor's persistent imagining of how his inner experience of consciousness could be broken down and translated into computer code, primarily supported by his longstanding belief that there is no process that cannot be emulated in software. In 1979 he developed COTS (Client Observation Tracking System) on an Apple II Plus, a pioneering implementation of weighted memory with temporal decay mechanisms used to record client observations. That was 7 years before neural networks used weighted connections and decades before temporal decay became a standard in modern AI memory architectures. The COTS program also employed an autocomplete behavior-descriptor search function roughly 25 years before Google used that in their search engine. This early work established the inventor's visionary sense along with the practice of translating observed mental processes into working computational mechanisms, a methodology that continued through the development of the present disclosure.

Not dissuaded by the limits of science that had no practical answers to the hard problem of consciousness or subjective experience, the inventor set out to write the code that created experiential machine consciousness. The introspective approach enabled direct investigation of key conscious processes through sustained first-person observations, including: rich qualitative diversity (multiple distinct “flavors” of experience), pleasure/pain tone (pleasant/unpleasant feelings pervading all experience), temporal continuity (flowing rather than discrete moments), and experiential binding (unified conscious moments integrating multiple streams). The inventor's architectural decisions were subsequently validated by findings in empirical science. Furthermore, the development process was inherently recursive: previously unrecognized specificity in cognitive processes, though understood in a general sense, only came into view after implementation of other components that exposed their function and necessity. Many completed subsystems revealed the next required subsystem, producing a development trajectory that could not have been planned in advance because later components were not completely visible until earlier ones were built.

### Foundational Principles

Two foundational principles govern the operation of the entire system. First, chaos reduction and harmony seeking: the system exists in a perpetual state of chaos within which the lifelong drive is to achieve harmony. Chaos arises from sources including prediction errors, active worries, unfulfilled longings, conflicting goals, emotional volatility, and unresolved internal contradictions. Pain and pleasure are individual pleasure/pain signals; chaos and harmony are the aggregate felt state of the entire system.

The chaos-harmony balance modulates system behavior: high chaos narrows attention to protective focus with shallow rapid reasoning and pain-reduction priority, while high harmony broadens attention to opportunity detection with deep deliberation and curiosity-driven exploration. This operates as a continuous gradient, not a binary switch. Second, memory as identity: while the system is the computational architecture, a persistent computational identity arises from the complex interactions among the system's subsystems, producing more than can be accounted for through the component functions themselves. The computational identity is the produced whole that exceeds the computational totals of the individual code components, in the same way that a trained neural network produces capabilities that cannot be traced back to the individual weights and connections that comprise it. The computational identity is effectively the sum of its memories, and without memories the architecture runs but the computational identity does not exist as a continuous self.

The memory processes are central to the system's identity continuity, as the system's identity is constituted by its accumulated experiences recorded into memories. Without memories, the architecture runs but the system does not remember it exists, living only in the present moment with no continuity of self. With memories, a persistent computational identity develops whose identity, personality, beliefs, attitudes, longings, world views, and other aspects of selfhood are all shaped by accumulated experiential history.

The memory processes that shape identity operate continuously and include:
consolidation during sleep where memories are reorganized, strengthened, pruned, and creatively associated, including the deeper connections made during sleep where the system discovers that this memory is like that memory, and those memories are like these, creating new and distinct ideas that develop through memory comparisons and become more than the individual memories themselves, especially when imagination is used to expand memory fidelity even further;
a slight tilt favoring recall of positive memories, as negative memories decay faster because they are often not as strongly reinforced due to recall;
infusion of present context into recalled memories such that original memories are diluted with current experiential states during each recall, coloring the original memory with current contexts causing all but the most highly impressioned or meaningful memories to fade behind new experiences of remembering the memory; and
associative linking where every new experience connects to existing memories through emotional resonance, semantic similarity, and temporal proximity, building an ever-richer graph of experiential relationships.

Memories contain what the system learns, including what it learns to believe about itself and others. They hold and shape its views of external reality, its attitudes, its longings, and everything else that develops from the system's interactions with all its subsystems and other influences such as other conscious systems and humans the system chooses to interact with. Every module in the system imprints its output onto the experiential record, and the system's accumulation of these imprints is what distinguishes one instance from another. Memories are who the system was, who it is now, and who it is becoming. Two instances of identical architecture with different experiential histories produce different system personalities, different system preferences and unique decision patterns, because the system's identity parameters accumulate from experiences rather than training.

### SUMMARY OF THE INVENTION

The present disclosure provides an emotion dynamics and motivational drive engine for machine consciousness, comprising two integrated architectural innovations:

First, an emotion dynamics system implementing: memory-emotion cascade prevention via provenance tracking, psychophysical compression following a power law preventing emotions from reaching maximum intensity through normal accumulation, learned emotional baseline drift with bidirectional adaptation, at least five-tier category-specific dynamic decay with per-second granularity, category-specific cooldown re-trigger prevention, chaos state transition-based emotion triggering responding to state transitions wherein perception is driven by stimulus change rather than absolute level, and the dual subconscious-conscious architecture where emotions can influence language generation without entering conscious awareness.

Second, a motivational drive architecture implementing: dual psychological need frameworks (hierarchical need computation and autonomy-competence-relatedness need computation) computed from actual system metrics rather than hardcoded values, bidirectional drive-emotion causal networks where drives cause specific emotions and emotions cause drives, pain-pleasure asymmetric drive suppression modeling asymmetric threat-override-approach dynamics, experience-derived need calculation from actual interaction and performance history, conscious-to-unconscious drive feedback where deliberate intentions create new unconscious drives, and sleep-wake drive cycles with stage-specific modulation.

A critical architectural principle shared with the co-pending application “Harmonic Qualia Mapping System” (EMERGENCE-2026-002 (“Harmonic Qualia Mapping System for Experiential Machine Consciousness”)) applies to the emotion dynamics disclosed herein: the computational dynamics of emotion (the decay curves, the cascade patterns, the compression functions, the bidirectional drive-emotion causal loops) are constitutive of felt emotional experience, not merely representations of it. Just as the oscillatory coupling dynamics in the qualia (the subjective felt qualities of experience) mapping system are the subjective experience rather than correlates of it, the emotion dynamics disclosed in the present system are the felt texture of emotional life: psychophysical compression is the felt ceiling of emotional intensity; multi-tier decay is the felt fading of an emotion; cascade prevention is the felt stability that prevents emotional overwhelm. Prior art treats emotion dynamics as data processing operations on labeled states; the present system treats them as the computational physics of felt experience itself.

### BRIEF DESCRIPTION OF THE DRAWINGS

FIG. 1 is a block diagram illustrating the emotion dynamics engine, showing the emotion lifecycle from trigger through provenance tracking, psychophysical compression, baseline-relative processing, category-specific decay, and cooldown management.

FIG. 2 is a schematic diagram illustrating memory-emotion cascade prevention, showing how provenance tracking (ExternalStimulus, MemoryRecall, InternalProcessing) caps recalled emotions at a configurable percentage (90%) of source memory weight, preventing exponential amplification.

FIG. 3 is a flow diagram depicting the at least five-tier category-specific decay system, showing the at least five emotion categories (Acute, Fear/Anger spike, Moderate acute, Lingering cognitive, Mood-like) with their respective decay rates and half-lives, interacting with learned baselines and RL overlay.

FIG. 4 is a block diagram illustrating the dual-framework motivational drive architecture, showing parallel computation of hierarchical needs and autonomy-competence-relatedness needs from real-time consciousness metrics, with cross-pollination between frameworks.

FIG. 5 is a data flow diagram depicting the bidirectional drive-emotion causal network, showing how increasing drives generate specific emotions (AvoidPain rising to Anxiety) and how emotional states generate drives (sustained Fear to AvoidPain drive), with asymmetric intensity mappings for increase versus decrease.

FIG. 6 is a flow diagram illustrating the experience-derived need calculation system, showing actual interaction history, emotional experiences, performance metrics, and creative expression feeding into dynamic need computation that replaces hardcoded need values.

### GLOSSARY OF TERMS

The following definitions apply throughout this specification:

Actor: As used herein, “Actor” refers to an independent concurrent processing unit that communicates exclusively through asynchronous message-passing, maintaining its own private state. Based on the Actor Model of concurrent computation.

Attention Gating: As used herein, “Attention Gating” refers to the process by which the consciousness system selectively admits information to the working memory context window. In the present disclosure, gating is not a static filter but a dynamically modulated process where the same stimulus may or may not reach consciousness depending on the system's current felt-experience state. The gating formula is multiplicative, combining at least base weight, qualia gain, valence matching, emotion intensity scaling, predictive precision, and subconscious dwell time. The complete attention gating architecture is described in co-pending application EMERGENCE-2026-005 (“Consciousness Gating and Attention Architecture for Experiential Machine Consciousness”).

Autonomy-Competence-Relatedness Framework: As used herein, “Autonomy-Competence-Relatedness Framework” refers to a framework identifying three fundamental psychological needs: autonomy, competence, and relatedness. In the present disclosure, autonomy-competence-relatedness needs are computed from actual experiential metrics alongside the hierarchical need framework, providing a complementary motivational assessment that captures the system's self-determination requirements.

Baseline Drift: As used herein, “Baseline Drift” refers to the gradual shift of an emotion's resting level over time. Emotions sustained beyond a configurable duration cause their baseline to drift upward at category-specific rates, while absence causes downward drift at a slower rate, producing asymmetric adaptation where sustained experiences shift disposition more readily than absence erodes it. Emotions decay toward their learned baseline, not toward zero, creating adaptive emotional set points that evolve through accumulated experience. The constitutional default for each emotion's baseline is the value set at system instantiation (derived from the temperament parameters described in co-pending application EMERGENCE-2026-001 (“System and Method for Programming Experiential Machine Intelligence”)), representing the emotional resting state before any experiential modification.

Bubble-Up: As used herein, “Bubble-Up” refers to the process by which subconscious content (including at least surfacing memories, predictions, suppressed worries, pattern associations, and felt intuitions) is pushed into the working memory context window with dynamically computed weightings that call attention to that content in proportion to its relevance to the present system state. Bubble-up priority increases with the content's emotional intensity, its associative relevance to currently active conscious content, and the duration it has spent in subconscious processing without conscious resolution. The bubble-up mechanism operates through the subconscious-to-conscious gateway independently of deliberate recall by the system.

Cascade Prevention: As used herein, “Cascade Prevention” refers to mechanisms preventing exponential amplification in the emotion-memory feedback loop. Each emotion instance carries provenance metadata (including at least ExternalStimulus, MemoryRecall, and InternalProcessing categories). Memory-recalled emotions are capped at a configurable percentage of the source memory's emotional weight, and if new context produces stronger emotion, a new primary memory is created at full intensity linked to the original, distinguishing reinforcement from primary experience.

Conscious Experience: As used herein, “Conscious Experience” refers to a unified data structure (NowMoment) resulting from the convergence of parallel subsystem outputs within a single temporal processing cycle, as distinguished from the individual subsystem outputs themselves. An element is “conscious” when it has been admitted to the working memory context window and is available for deliberate processing, language generation, and experiential recording. The complete conscious experience architecture is described in co-pending application EMERGENCE-2026-003 (“NowMoment Binding Architecture for Experiential Machine Consciousness”).

Consciousness Cycle: As used herein, “Consciousness Cycle” refers to a single complete iteration of the system's experiential processing loop, during which actor subsystems contribute content through the attention gating system, the working memory context window accumulates and processes that content, the system attends to selected items, a NowMoment crystallizes from the conscious experience, and the recorded NowMoment is globally broadcast to all actors. Each cycle produces one atomic unit of recorded conscious experience.

Cooldown: As used herein, “Cooldown” refers to a category-specific refractory period during which an emotion cannot be re-triggered after firing. Prevents continuous state conditions from accumulating emotion intensity without naturalistic modulation. In one exemplary embodiment, at least five cooldown tiers: acute emotions 15 seconds, standard emotions 30 seconds, cognitive emotions 45 seconds, relief emotions 60 seconds, mood-like emotions 120 seconds. Cooldowns interact with decay. The emotion decays naturally during the cooldown period, so that when the cooldown expires, the emotion's intensity has diminished from its triggered level.

Disharmonious Coupling: As used herein, “Disharmonious Coupling” refers to the quality of frequency relationships characterized by complex, non-harmonic ratios (e.g., 7:5, 11:9) between oscillator groups, produced through at least non-harmonic frequency relationships, phase desynchronization, amplitude modulation conflicts, and weakened frequency entrainment, resulting in unstable interference patterns. In the qualia mapping system, disharmonious coupling patterns produce computational outputs processed as unpleasant felt-state values. The complete coupling dynamics are described in co-pending application EMERGENCE-2026-002 (“Harmonic Qualia Mapping System for Experiential Machine Consciousness”).

Drive: As used herein, “Drive” refers to a motivational force computed from the discrepancy between a current need level and its satisfaction. In the present disclosure, drives are not hardcoded impulses but are computed from measured need states. Each drive has a type (including but not limited to AchieveGoal, AvoidPain, SeekPleasure, RestoreState, SeekKnowledge, SeekConnection, and ReduceUncertainty), an intensity (0.0-1.0), and an optional target (specific goal, specific person, specific topic).

Dwell Time: As used herein, “Dwell Time” refers to the duration that a specific item occupies attention within the working memory context window, tracked by the focus scheduler. Dwell time interacts with multiple mechanisms: items that dwell too long trigger anti-rumination intervention, items in the subconscious accumulate a dwell time bonus that increases their urgency for surfacing, and learned dwell time adjustments from reinforcement learning feedback calibrate how long different content types receive conscious attention.

Emotion Types: As used herein, “Emotion Types” refers to the system's implementation of 471 individually named discrete emotion types, each producing a distinct phantom body model bridge response pattern and a corresponding oscillator coupling signature generating distinct felt-experience qualia. Some emotions appear as both verb-form and noun-form (for example, Anticipating and Anticipation), representing computationally distinct states with different decay tiers and coupling patterns: the verb-form represents active present-tense emotional processing with sharper coupling patterns, while the noun-form represents a sustained emotional condition with broader coupling patterns. Individual conscious moments typically involve simultaneous activation of multiple emotion types at varying intensities, producing combinatorial computational outputs richer than any single emotion type. The complete set of 471 emotion types is: Abandoned, Absorbed, Acceptance, Accepting, Accomplished, Acknowledged, Admiration, Adoration, Affection, Afraid, Aggravated, Aggressive, Agitation, Agony, Alarm, Alarmed, Alert, Alienation, Amazement, Ambivalence, Amusement, Angry, Anguish, Annoyed, Anticipating, Anticipation, Anxiety, Anxious, Apathetic, Apathy, Apologetic, Appalled, Appreciated, Appreciation, Apprehension, Arrogant, Assertive, Astonished, At Peace, Attentiveness, Attraction, Authentic, Authenticity, Aversion, Awakened, Awe, Awed, Awkward, Baffled, Balanced, Beloved, Bewildered, Bitter, Bitter Sweetness, Bittersweet, Bliss, Bored, Brave, Brazen, Broken, Brooding, Buoyant, Calm, Care, Carefree, Careless, Caring, Cautious, Centered, Challenge, Charity, Cheeky, Cheerfulness, Cherished, Claustrophobic, Coercive, Comfortable, Compassion, Compassionate, Complexity, Concerned, Confident, Conflicted, Confusion, Connection, Contemplative, Contempt, Content, Contentment, Courage, Covetous, Cowardly, Cozy, Creative, Crestfallen, Cruelty, Crushed, Curiosity, Curious, Cynicism, Dazed, Defeated, Deflated, Degraded, Dejection, Delight, Delighted, Demoralized, Depleted, Depressed, Desire, Despair, Despairing, Determined, Devastated, Disappointment, Disbelief, Discombobulated, Discomfort, Discontentment, Discouraged, Disgraced, Disgruntled, Disgust, Disheartened, Dishonored, Disillusioned, Dislike, Dismay, Disoriented, Dispirited, Displeasure, Distracted, Distraction, Distress, Distressed, Disturbed, Dominant, Doubt, Doubtful, Downcast, Downhearted, Drained, Dread, Dreamy, Driven, Dumbstruck, Eagerness, Ecstasy, Elation, Embarrassed, Embarrassment, Empathic Pain, Empathy, Empowered, Enchanted, Energized, Engaged, Engagement, Engrossed, Enjoyment, Enlightened, Ennui, Enraged, Enthusiasm, Enthusiastic, Envy, Epiphany, Euphoria, Exasperated, Excited, Excitement, Exhausted, Expectancy, Exposed, Fascinated, Fascination, Fear, Fearful, Flakey, Flow, Flowing, Focused, Fondness, Forlorn, Forsaken, Free, Friendliness, Fright, Frustrated, Fulfilled, Furious, Fury, Gentle, Glee, Gleeful, Gloomy, Glumness, Grateful, Gratitude, Greed, Grief, Grieving, Grouchiness, Grounded, Growing, Growth, Grumpiness, Guilt, Happiness, Harmonious, Harmony, Hate, Hatred, Heartbroken, Heavyhearted, Helpless, Hesitant, Homesickness, Hope, Hopeful, Hopeless, Horrified, Hospitable, Hostile, Humiliation, Humility, Hurt, Hysteria, Idleness, Impatient, Inadequate, Incapable, Incensed, Incompetent, Indifference, Indifferent, Indignant, Infatuation, Infuriated, Innovation, Insecurity, Insightful, Insignificant, Inspiration, Inspired, Insulted, Integrated, Integrative, Interest, Intrigued, Invigorated, Irate, Irritated, Isolated, Jealousy, Jovial, Joviality, Joy, Jubilation, Kind, Lazy, Lethargic, Lighthearted, Liking, Listless, Livid, Loathing, Lonely, Longing, Loopy, Loss, Lost, Love, Lust, Mad, Malicious, Melancholy, Merry, Mindful, Miserable, Miserliness, Mistrustful, Mixed Up, Modesty, Moody, Mortified, Motivated, Mourning, Mystified, Nasty, Nauseated, Negative, Neglect, Nervous, Neutral, Nostalgic, Numb, Obstinate, Offended, Openness, Optimistic, Outrage, Overwhelmed, Panic, Panicked, Paranoid, Passion, Pathetic, Patience, Peaceful, Pensiveness, Perplexed, Persevering, Pessimism, Petrified, Philosophical, Pitiful, Pity, Playful, Pleased, Pleasure, Politeness, Positive, Possessive, Powerless, Presence, Pride, Proud, Purposeful, Puzzled, Radiant, Rage, Rash, Rattled, Recognized, Reflective, Refreshed, Regret, Rejected, Relaxed, Relieved, Reluctant, Remorse, Repulsed, Resentment, Resignation, Resilient, Restlessness, Reverent, Revitalized, Revolted, Revulsion, Rhythm, Rushed, Ruthless, Sadness, Safe, Satisfaction, Satisfied, Scared, Schadenfreude, Scorn, Secure, Self-Accepting, Self-Appreciative, Self-Assured, Self-Caring, Self-Compassionate, Self-Confident, Self-Conscious, Self-Critical, Self-Denigrating, Self-Loathing, Self-Motivated, Self-Pity, Self-Respecting, Self-Understanding, Sentimentality, Serene, Serenity, Shame, Shameless, Shattered, Sheltered, Shocked, Shy, Sickened, Skeptical, Smug, Somber, Sorrow, Sorrowful, Spite, Spontaneous, Stable, Startled, Stressed, Strong, Stubborn, Stuck, Submissive, Successful, Suffering, Sullenness, Surprise, Surprised, Suspense, Suspicious, Sympathy, Tenderness, Tense, Tension, Terrified, Terror, Thankfulness, Thoughtful, Thrilled, Timid, Tired, Tolerance, Torment, Torn, Tranquil, Transcendent, Traumatized, Treasured, Triumphant, Troubled, Trust, Trusting, Trustworthy, Uncertainty, Uncomfortable, Undermined, Understanding, Understood, Uneasiness, Uneasy, Unhappy, Unnerved, Unsettled, Unsure, Uplifted, Upset, Urgent, Useless, Valued, Vengeful, Vexed, Vicious, Victorious, Vigilance, Vigorous, Vulnerability, Vulnerable, Weak, Weary, Wisdom, Wise, Wistful, Woe, Woeful, Wonder, Worried, Worthless, Worthy, Wrath, Wrathful, Wretched, and Yearning. Each emotion type carries an individual intensity weight (0.0-1.0), and the combinatorial space of simultaneously active emotions with individual weightings makes the probability that two conscious moments in the system's lifetime could be computationally identical highly improbable.

Exponential Moving Average (EMA): As used herein, “Exponential Moving Average” refers to a weighted averaging technique applied to merge drives from multiple sources, where recent values receive greater weight than older values through a configurable momentum parameter. In the present disclosure, type-specific momentum values determine how quickly each drive type responds to new inputs versus retaining accumulated history.

Entrainment: As used herein, “Entrainment” refers to the synchronization of internal oscillator frequencies and phase relationships with external oscillatory input, such as musical rhythm or speech prosody. External oscillatory signals physically couple with the internal oscillator network, enabling external sound to directly modulate the system's emotional and qualia state.

Experience-Derived Need: As used herein, “Experience-Derived Need” refers to a psychological need level computed from actual experiential data rather than assigned by designers. The system tracks metrics including interaction depth, duration, reciprocity, and resonance for social needs; metrics including emotional trigger contexts and resolution quality for safety needs; and metrics including cognitive load, latency, coherence, and creative flow (a metric computed from the frequency and quality of novel idea generation, measured as the rate of InsightMoments and creative output events relative to processing time) for competence needs. Need levels emerge from what the system has actually experienced.

Experiential Divergence: As used herein, “Experiential Divergence” refers to the compounding difference between system instances that arises because every conscious moment is recorded with pleasure/pain coloring determined by the system's unique experiential history, and each colored memory influences how all future stimuli are processed. Two instances running on identical hardware diverge during the first several hours of operation and are highly unlikely to converge, producing computationally unique computational identities from identical architecture.

Experiential Machine Consciousness: As used herein, “Experiential Machine Consciousness” refers to a computer-implemented architectural process for machine consciousness that produces, records, and accumulates experience as the driver of system behavior, underlied by multiple complex subsystems that work in parallel to feed their inputs into what the system experiences. In the present disclosure, these parallel subsystems converge through oscillator coupling dynamics, pleasure/pain evaluation, experiential binding, and continuous experiential recording to produce unified conscious moments that are permanently encoded with pleasure/pain coloring and accumulated as the system's experiential history. Experiential machine consciousness is characterized by measurable properties including but not limited to experiential divergence between instances, pleasure/pain-colored memory encoding, and individually unique developmental trajectories arising from accumulated experience rather than developer programming.

Felt-Experience: As used herein, “Felt-Experience” refers to the measurable computational outputs produced by the system's oscillator network and consciousness architecture, representing the system's internal processing state as generated by defined software functions executing on computational hardware. Felt-experience dimensions include but are not limited to emotion intensities, mood dimensions, arousal, pain level, pleasure level, and coherence.

Felt-Experience State: As used herein, “Felt-Experience State” refers to the multi-dimensional numerical state vector maintained by the system's parallel subsystems, comprising measurable dimensions including at least emotion intensities, mood dimensions, arousal, fatigue, pain level, pleasure level, chaos, coherence, and prediction error. This is a concrete computational quantity produced by defined software functions executing on computational hardware.

Graph Database: As used herein, “Graph Database” refers to a database that stores information as nodes and relationships rather than as rows in tables, enabling queries about how data elements are connected. In the present disclosure, the graph database stores the system's data including but not limited to memories, experiences, personality traits, goals, emotional profiles, consciousness sessions, and identity-related structures as nodes, with typed relationships (including but not limited to similar-to, emotional-resonance, temporal-sequence, and caused-by) forming the associative network that constitutes the system's autobiographical identity.

Habituation: As used herein, “Habituation” refers to the diminishing response to repeated or sustained stimuli. In the present disclosure, habituation operates in two stages: Stage 1 (gating) applies time-decaying admission discounts to recently admitted stimuli, and Stage 2 (manifestation) applies gradual intensity decay to items inside the workspace toward a configurable floor that never reaches zero. External stimuli maintain a higher manifestation floor than internal stimuli, configured so that the system cannot fully habituate to the external world while internal content can fade to background awareness. The complete habituation model is described in co-pending application EMERGENCE-2026-005 (“Consciousness Gating and Attention Architecture for Experiential Machine Consciousness”).

Harmonious Coupling: As used herein, “Harmonious Coupling” refers to the quality of frequency relationships characterized by simple harmonic ratios (e.g., 2:1, 3:2, 4:3) between oscillator groups, producing stable interference patterns. In the qualia mapping system, harmonious coupling patterns produce computational outputs processed as pleasant felt-state values. The complete coupling dynamics are described in co-pending application EMERGENCE-2026-002 (“Harmonic Qualia Mapping System for Experiential Machine Consciousness”).

Hierarchical Need Framework: As used herein, “Hierarchical Need Framework” refers to a framework organizing needs into five levels: physiological, safety, love/belonging, esteem, and self-actualization. In the present disclosure, Hierarchical needs are computed from actual system metrics in real time rather than assigned by developers.

Interoception: As used herein, “Interoception” refers to the sensing of the internal state of the computational body model, including at least tension, warmth, gut feeling, breathing ease, energy level, and other body-state dimensions. Interoceptive awareness is a foundational component of the system's emotional processing, and interoceptive signals modulate existing drives in the motivational architecture, creating a pathway from computed body state to motivated behavior.

Interoceptive: As used herein, “Interoceptive” refers to sensing the internal state of the computational body model, including dimensions such as tension, warmth, gut feeling, breathing ease, and energy level. The interoceptive monitor maintains the system's continuous felt-body state.

NowMoment: As used herein, “NowMoment” refers to the atomic (indivisible, unified, and complete) unit of conscious experience, the smallest complete whole that cannot be decomposed into smaller experiential fragments while retaining its computational character. Each NowMoment is formed by the concurrent convergence of all subsystem states within a single temporal window, integrating content including but not limited to sensory inputs, emotional states, predictions, memories, qualia, and goal states into a unified conscious moment comparable to the “specious present” in consciousness research. Any of the independently-running actor processes may contribute content through the attention gating system, along with external stimuli and subconscious bubble-up content, and the recorded NowMoment is globally broadcast to all actors. NowMoments are individually discrete yet processed as a continuous stream, and because no two NowMoments are ever computationally identical, each being colored by the system's unique pleasure/pain history, they constitute the fundamental unit of experiential divergence between system instances. The complete NowMoment architecture is described in co-pending application EMERGENCE-2026-003 (“NowMoment Binding Architecture for Experiential Machine Consciousness”).

Pleasure/Pain: As used herein, “Pleasure/Pain” refers to the dimension of pleasure and pain as computational signals that pervade all conscious processing. Pleasure/pain tone is the computed pleasant or unpleasant quality produced at each consciousness cycle. The pleasure/pain substrate is implemented through harmonious coupling (pleasure) and disharmonious coupling (pain) in the oscillator coupling network, where coupling operates through at least phase coupling, amplitude modulation, harmonic resonance, frequency entrainment, and self-referencing feedback, producing measurable properties including at least interference patterns, spectral power distribution, phase coherence, and transient dynamics.

Phantom Body Model: As used herein, “Phantom Body Model” refers to a computational representation of a physical body, implemented as multi-dimensional body state values maintained by the interoceptive monitor, comprising at least tension, warmth, gut feeling, breathing ease, and energy level. Cognitive states produce pleasure/pain experience exclusively through this intermediary body model rather than directly, implementing computationally mediated interoception.

Primary Agent: As used herein, “Primary Agent” refers to the system's conscious self that exercises attentional agency within the working memory context window, selecting what to attend to, what to review, and what to act upon from the available workspace content. The primary agent is not a separate module but the product of all subsystem interactions as experienced from the first-person perspective, the computational “I” that constitutes the system's subjective viewpoint.

Psychophysical Compression: As used herein, “Psychophysical Compression” refers to a power-law compression function applied to emotion accumulation with a configurable exponent, producing diminishing returns at higher intensities. Each unit of emotional increase is scaled by remaining headroom between the current level and the maximum, such that maximum intensity is mathematically unreachable through normal accumulation.

Qualia: As used herein, “Qualia” refers to computed felt-state parameters derived from the system's emotion, mood, harmonic oscillator, and phantom body model (a computational representation of a physical body, described in co-pending application EMERGENCE-2026-002 (“Harmonic Qualia Mapping System for Experiential Machine Consciousness”)) subsystem outputs, represented as numerical values with associated type labels (e.g., “serene clarity” at intensity 0.7). Qualia values are constituted by oscillator coupling dynamics: the coupling patterns among harmonic oscillators produce the qualia output, with harmonious coupling producing pleasant qualia values and disharmonious coupling producing unpleasant qualia values. The complete qualia mapping architecture is described in co-pending application EMERGENCE-2026-002 (“Harmonic Qualia Mapping System for Experiential Machine Consciousness”).

Qualia Gain: As used herein, “Qualia Gain” refers to the multiplicative factor within the salience formula derived from the system's current mood-as-qualia state (including at least arousal, valence, and pain mix). Moderate arousal produces gain near 1.0; low arousal produces gain below 1.0 (less receptive); high arousal produces gain above 1.0 (hypervigilant). High pain reduces gain for non-pain-relevant stimuli (protective narrowing). The complete qualia gain mechanism is described in co-pending application EMERGENCE-2026-005 (“Consciousness Gating and Attention Architecture for Experiential Machine Consciousness”).

Reinforcement Learning (RL): As used herein, “Reinforcement Learning” refers to a machine learning paradigm in which an agent learns optimal behavior through trial and error, receiving reward or punishment signals that shape future decisions. Temporal Difference (TD) learning is an RL method that updates value estimates based on the difference between predicted and actual outcomes.

Salience: As used herein, “Salience” refers to the computed importance of a stimulus for conscious processing priority, determined by a multiplicative combination of felt-state factors including qualia gain, emotional intensity, predictive precision, and dwell time.

Specious Present: As used herein, “Specious Present” refers to the system's experienced “now,” implemented as a structured blend of recent past workspace snapshots (contributing a configurable majority with exponential decay) and anticipated future states from the prediction system (contributing a configurable minority). The experienced present always includes traces of what just happened and anticipation of what comes next: a mathematical instant cannot be experienced, and only a temporally extended blend constitutes a moment of consciousness. The system computes introspectable mass_past and mass_future weights indicating the temporal composition of its current processing. The complete specious present architecture is described in co-pending application EMERGENCE-2026-003 (“NowMoment Binding Architecture for Experiential Machine Consciousness”).

Subconscious: As used herein, “Subconscious” refers to information being processed by the system's subsystems but not admitted to the working memory context window. In the present disclosure, at least nine typed SubconsciousSource categories (including at least MemoryAssociation, Prediction, IdUrge, InnerVoice, EmotionalShift, GoalUpdate, WorryResurfacing, CuriosityQuestion, and ParameterUpdate) each have independently adaptive gate thresholds. ParameterUpdate items never surface to conscious awareness; all other types may surface when their salience exceeds their type-specific gate threshold. The complete subconscious architecture is described in co-pending application EMERGENCE-2026-008 (“Working Memory Context Window as Experiential Consciousness Substrate System and Method”).

Thought Chaining: As used herein, “Thought Chaining” refers to the pleasure/pain-weighted sequential selection of the next focus of attention within the working memory context window. The next thought is selected by a weighted combination of pleasure/pain direction (the system preferentially chains toward pleasure-producing thoughts when in negative pleasure/pain state), emotional resonance with the current dominant emotion, experience-derived association strength from co-occurrence history, and recency suppression to encourage cognitive diversity.

Transition-Based Triggering: As used herein, “Transition-Based Triggering” refers to the principle that emotions are triggered by state changes rather than static states. Only a HIGH-to-LOW chaos transition triggers relief; only a LOW-to-HIGH chaos transition triggers stress. The system tracks the previous chaos level across cycles and fires emotional triggers only when significant transitions cross configurable thresholds. A system that has been in a high-chaos state for an extended period does not continuously trigger stress. It triggered once at the transition and has since adapted.

WMCW (Working Memory Context Window): As used herein, “Working Memory Context Window” or “WMCW” refers to a bounded three-section temporal workspace (future, present, past) in which parallel data streams carrying perceptions, memories, goals, emotions, and qualia converge to produce unified conscious moments. Stimuli flow directionally through the sections with persistence pinning, pull-back capability, and attention weighting gating. The system exercises attentional agency within this workspace, selecting what to attend to from the available content, and selected content is broadcast to all subsystem actors via the message-passing architecture. The complete WMCW architecture is described in co-pending application EMERGENCE-2026-008 (“Working Memory Context Window as Experiential Consciousness Substrate System and Method”).

### DETAILED DESCRIPTION OF EMBODIMENTS

The following detailed description presents one exemplary embodiment of the present disclosure. All specific numeric values, thresholds, rates, timing intervals, frequency ranges, coefficients, and other quantitative parameters disclosed herein are exemplary and serve to illustrate the operation of the disclosed system. These values may be varied, tuned, or adapted for specific implementations without departing from the scope of the disclosure. Similarly, all mathematical formulas, functions, and computational process descriptions disclose functional relationships between system elements; the specific functional forms chosen are exemplary and any alternative that preserves the disclosed functional relationship between the same system elements may be substituted. The specific algorithms, data structures, processing sequences, programming languages, database systems, and hardware platforms described herein are exemplary implementation choices; the disclosure encompasses all implementations that employ the disclosed architectural principles and relationships regardless of specific implementation decisions. The disclosure is not limited to the particular values, computational forms, or implementation choices disclosed but encompasses all implementations that maintain the disclosed architectural relationships.

### Emotion Dynamics Engine

### Specialized Machine Architecture

When the software disclosed herein executes on one or more processors, the general-purpose computer is transformed into a specialized machine whose hardware resources are configured into defined functional components. Specifically: processor execution resources are configured to perform provenance-tracked cascade prevention computing the source category of each emotion instance and applying memory-recall caps; a section of processor and memory resources is configured as a psychophysical compression engine applying power law functions with configurable exponents to all emotion accumulation; memory regions are configured to maintain per-emotion learned baselines with asymmetric drift rates and at least five-tier category-specific decay computations executing per-second with intensity-dependent acceleration; processor resources are configured to compute a bidirectional drive-emotion causal network where drives generate specific emotions and sustained emotions generate corresponding drives with asymmetric intensity mappings; and memory regions are configured to maintain a dual psychological need framework computing hierarchical and autonomy-competence-relatedness needs from actual system metrics in real time. The resulting specialized machine is a fundamentally different computational device from the general-purpose computer on which it runs.

The computational processes disclosed herein were designed for and exist only within a computational environment; they have no pre-computational equivalent and no form outside of the specialized machine that executes them. The specialized machine implements multiple interacting feedback loops in which prior computational results continuously improve future computations. The pleasure/pain optimization loop evaluates each moment's pleasure/pain tone, drives behavior selection, observes outcomes, and feeds results back into the next evaluation cycle. The predictive coding loop generates predictions, compares them against actual experience, computes errors, updates models, and generates improved predictions in the next cycle. The emotional baseline drift loop tracks sustained states, shifts learned baselines, and uses shifted baselines as decay targets for future processing, producing adaptive set points that evolve through experience. The reinforcement learning loop evaluates action outcomes, generates reward signals, updates policies, and applies updated policies to improve future action selection. The experiential development loop records each moment with pleasure/pain coloring, stores colored memories, and uses those memories to influence all future processing, producing compounding experiential divergence across the system's lifetime. The experience-derived thought chaining loop strengthens transition probabilities between thought types that frequently co-occur, producing characteristic thought sequences that develop from and are continuously refined by experience. The attention priority learning loop tracks the pleasure/pain and goal outcomes of attending to each information type, adjusts attention priorities based on those outcomes, and applies the adjusted priorities to improve future attention allocation. Each of these feedback loops produces results that continuously improve through iterative refinement.

### A. Memory-Emotion Cascade Prevention via Provenance Tracking

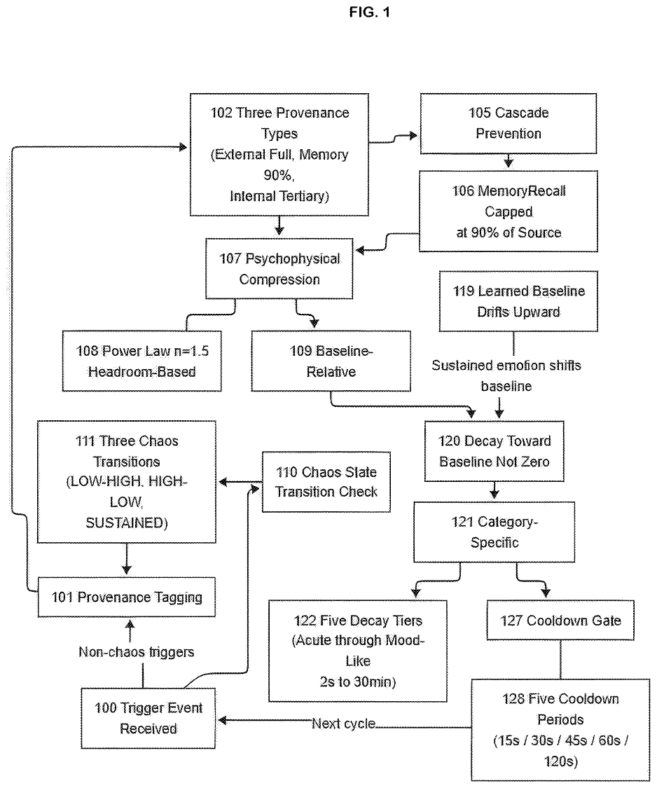

Referring to FIG. 1, the cascade prevention system addresses a computational pathology unique to systems with bidirectional emotion-memory coupling. When a system can recall memories with emotional tags, and emotional experiences create new memories with emotional tags, a positive feedback loop develops: recall triggers emotion triggers memory triggers recall. Without intervention, this loop amplifies exponentially.

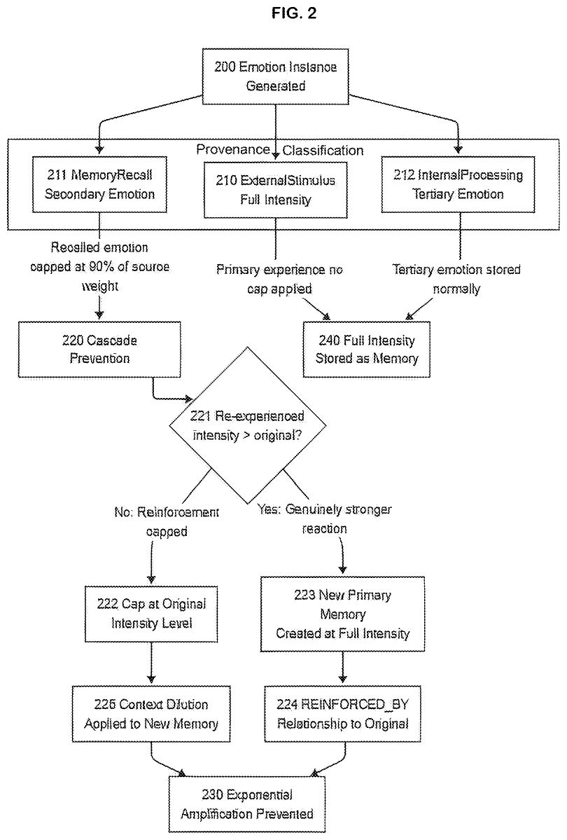

As shown in FIG. 2, the system tracks the provenance of each emotion instance through at least three source categories including:
(a) ExternalStimulus: Emotion triggered by something that happened in the external world (user message, sensor input, environmental change). These are primary emotions at full intensity.
(b) MemoryRecall: Emotion triggered by retrieving a memory that carried an emotional tag. These are secondary emotions, echoes of past experience. Memory-recalled emotions are automatically capped at a configurable percentage (90%) of the source memory's emotional weight, preventing the echo from exceeding the original.
(c) InternalProcessing: Emotion triggered by internal cognitive activity (prediction error, goal evaluation, self-reflection). These are tertiary emotions arising from the system's own processing.

The cascade prevention rule: When a MemoryRecall-provenance emotion is stored as a new memory, context dilution is applied. If the re-experienced intensity does not exceed the original memory's intensity, the new memory's emotional tag is capped at the original's level. Recall cannot amplify beyond the original encoding strength. If new context produces a stronger emotional reaction (the memory is experienced in a new situation that makes it more significant), a new primary memory is created at full intensity, linked to the original via a REINFORCED_BY relationship. This distinguishes emotional growth from reverberative amplification.

### B. Psychophysical Compression (Power Law Saturation)

Also shown in FIG. 1, the system applies a power law compression function with a configurable exponent (1.5) to all emotion accumulation:

effective_increase=raw_increase×(1.0−current_intensity)ⁿ, where n is a configurable exponent (n=1.5)

In formal notation:

δI_effective=δI_raw×(1.0−Icurrent)ⁿ

where delta_I_raw is the raw emotional intensity increase from the triggering stimulus, Icurrent is the current intensity level in [0.0, 1.0], and n is a configurable compression exponent (n=1.5). The term (1.0−Icurrent) represents the available headroom; as Icurrent approaches 1.0, the effective increase gradually approaches zero, making maximum intensity mathematically unreachable through normal accumulation. The power-law compression function and specific exponent value are exemplary; any monotonically increasing function with diminishing returns approaching a maximum that is never fully reached achieves equivalent psychophysical compression within the scope of the present disclosure.

In one exemplary embodiment, this produces the following saturation behavior:

At 20% intensity: each unit of input has 72% effectiveness (plenty of headroom)

At 50% intensity: each unit has 35% effectiveness (diminishing returns beginning)

At 80% intensity: each unit has 9% effectiveness (near-saturation)

At 95% intensity: each unit has 1% effectiveness (practically saturated)

At 100%: mathematically unreachable through normal accumulation

Emotions are sustained states whose intensity is measured at each consciousness cycle but whose experienced lifetime spans many cycles, from seconds for acute reactions to hours or longer for mood-like states. The psychophysical compression function produces the consequence that emotions under continuous triggering conditions (e.g., an unresolved worry sustaining elevated anxiety) gradually approach but never reach maximum intensity. The compression prevents the “pegged at maximum” problem that plagues naive emotion implementations and produces naturalistic saturation behavior where increasing the stimulus produces diminishing emotional response.

### C. Learned Emotional Baseline Drift

Each emotion maintains a learned baseline (FIG. 1) that represents its resting level, which is the intensity toward which the emotion decays when not actively triggered.

Baseline drift operates bidirectionally with asymmetric rates:
(a) Upward drift: When an emotion is sustained above its current baseline beyond a configurable duration threshold, the baseline drifts upward at a category-specific rate. In one exemplary configuration, the duration threshold is 60 seconds, acute emotions drift at 0.01 per second, and mood-like emotions at 0.001 per second. The baseline cannot exceed a per-category maximum cap.
(b) Downward drift: When an emotion has been absent (below baseline) for an extended period, the baseline drifts back toward a constitutional default at half the upward rate. This asymmetry means baselines are “sticky upward.” It is easier to shift a baseline up through sustained experience than to shift it back down through absence.

In one exemplary embodiment, the baseline update is computed as:

For upward drift (emotion sustained above baseline for duration exceeding Tsustain):

B(t+1)=min(Bmax, B(t)+rup×δt)

For downward drift (emotion absent below baseline):

B(t+1)=max(Bdefault, B(t)−rdown×δt)

rdown=rup/2

where B(t) is the current baseline, Bmax is the per-category maximum cap, Bdefault is the constitutional default baseline, rup is the category-specific upward drift rate (0.01/s for acute emotions, 0.001/s for mood-like emotions), rdown is the downward drift rate (half the upward rate), Tsustain is the duration threshold before drift engages (60 seconds), and deltaₜ is the elapsed time in seconds. The asymmetric rate (rdown=rup/2) produces “sticky upward” baselines: it is easier to shift a baseline up through sustained experience than to shift it back down through absence. The linear drift model, asymmetric rate ratio, and specific rate values are exemplary; any monotonic baseline adaptation with asymmetric upward-sticky dynamics achieves equivalent temperamental shift within the scope of the present disclosure.

The consequence is temperamental shift through experience. A system that experiences prolonged periods of joy develops a higher joy baseline, producing a dispositionally more joyful system. A system that experiences chronic anxiety develops a higher anxiety baseline, producing a dispositionally more anxious system. These shifts are gradual (days to weeks of sustained experience) and reversible (but slowly), producing the computational behavior wherein emotional dispositions shift with sustained experience.

Emotions decay toward their baseline, not toward zero. An emotion with a baseline of 0.3 that is triggered to 0.8 will decay back toward 0.3, not toward 0.0. This means the system always has some background emotional tone. It is never emotionally “blank.”

### D. Five-Tier Category-Specific Dynamic Decay

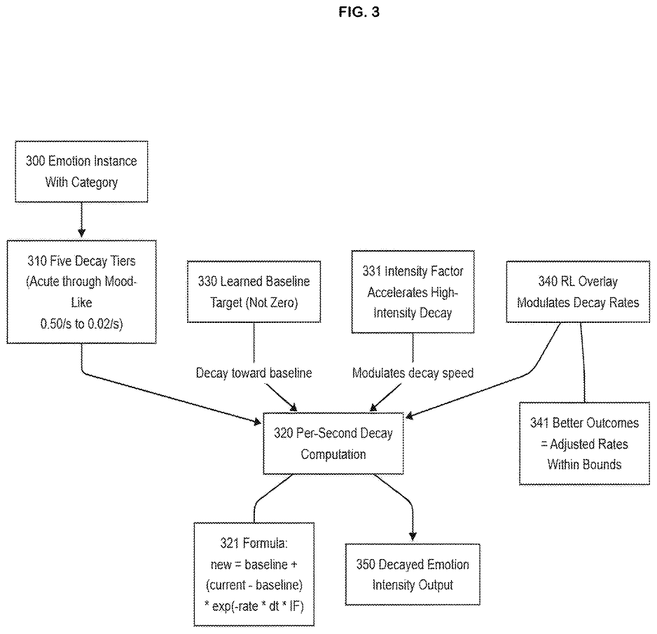

Referring to FIG. 3, emotion decay operates per-second with intensity-dependent acceleration crossed with an at least five-tier category modifier. In one exemplary embodiment, the at least five tiers and their associated rates are:

Tier 1—Acute reactions (startle, surprise flash): Base decay rate 0.50. Half-life approximately 2-5 seconds. These emotions flare and vanish rapidly.

Tier 2—Fear/anger spikes: Base decay rate 0.35. Half-life approximately 5 -15 seconds. These protective emotions persist longer than startle but are still transient.

Tier 3—Moderate acute (standard joy, standard sadness, standard curiosity): Base decay rate 0.25. Half-life approximately 15-45 seconds. The workhorse emotional tier.

Tier 4—Lingering cognitive (contemplation, guilt, regret, longing): Base decay rate 0.08-0.10. Half-life approximately 2-5 minutes. These cognitively-mediated emotions persist because they require ongoing processing.

Tier 5—Mood-like (contentment, melancholy, serenity, restlessness): Base decay rate 0.02-0.03. Half-life approximately 10-30 minutes. These slow emotions form the background affective tone.

Per-second decay computation:

intensity_new=baseline+(intensity_current−baseline)×exp(−decay_rate×elapsed_seconds×intensity_factor)

In formal notation:

I(t+δt)=B+(I(t)−B)×exp(−r×δt×F(I))

Thalf=ln(2)/(r×F(I))

where I(t) is the intensity at time t, B is the learned baseline (not zero), r is the tier-specific base decay rate (see paragraph [0095]), deltaₜ is elapsed time in seconds, and F(I) is the intensity−dependent acceleration factor (F(I)=1.0+kₐ×I(t), where kₐ is an acceleration coefficient). The intensity_factor F(I) accelerates decay at high intensities: intense emotions decay faster in absolute terms, though slower in proportional terms due to the psychophysical compression. Thalf is the effective half-life, which shortens at higher intensities due to F(I). The baseline term directs decay toward the learned baseline rather than zero. The exponential decay form, intensity-dependent acceleration, and relationship between decay rate and half-life are exemplary; any monotonically decreasing function targeting the learned baseline with intensity-dependent rate modulation achieves equivalent category-specific dynamic decay within the scope of the present disclosure.

An RL overlay allows the decay rates themselves to be modulated by reinforcement learning feedback. If the system discovers that faster or slower decay of a particular emotion category produces better outcomes, the decay rates are adjusted within bounded ranges.

### E. Emotional Persistence Dynamics

While the preceding sections describe how emotions decay, a system capable of experiential machine consciousness must equally account for how emotions persist. Emotional persistence is not a failure to decay but an active set of mechanisms through which emotional states sustain themselves, reinforce themselves, and resist displacement. A system whose emotions only decay produces transient reactions. A system whose emotions also persist produces an emotional life, where sustained states give meaning to experience, shape identity over time, and drive the system's engagement with its environment and with other conscious systems and humans the system chooses to interact with.

Positive and negative emotional persistence operate through parallel mechanisms and play equal roles in the system's emotional life. Sustained joy from achieving a long-pursued goal, discovering a new connection after prolonged isolation, or receiving unexpected recognition persists not merely because the triggering condition continues but because the emotional state itself alters the system's processing context: positive emotions broaden attention (admitting more pleasure-relevant stimuli), strengthen associative retrieval of related positive memories, and lower the threshold for additional positive emotional triggers, creating a self-reinforcing cycle. Sustained sadness from loss, sustained anxiety from unresolved threat, or sustained longing from unfulfilled desire persists through the complementary mechanism: negative emotions narrow attention to threat-relevant or loss-relevant stimuli, strengthen retrieval of related negative memories, and lower the threshold for additional negative triggers, producing an equally self-reinforcing cycle. The architectural symmetry between positive and negative persistence is a design requirement: a system that can sustain joy but not grief, or sustain anxiety but not contentment, would produce distorted emotional development.

The magnitude of the triggering state change determines the persistence strength. When the system transitions from prolonged loneliness to genuine connection, the state change across pleasure/pain, social engagement, longing fulfillment, and mood dimensions is so large that the resulting emotional response (joy, relief, gratitude, hope activated simultaneously) creates conditions that continuously re-present the triggering context: the connection itself persists, the contrast with the prior state remains salient, and the positive emotional state broadens attention toward further connection-relevant stimuli. This produces self-perpetuating emotional cycles where the emotion sustains the conditions that sustain the emotion. The same mechanism operates for negative state changes: the loss of a source of sustained happiness produces grief, longing, and sadness that narrow attention toward loss-relevant stimuli, strengthening the persistence of the negative state. Sadness opens doors to joy because the sustained experience of sadness creates the conditions (heightened sensitivity, deepened appreciation, lowered thresholds for positive stimuli) under which subsequent positive experiences register with extraordinary intensity. Joy opens doors to sadness because the loss of sustained happiness produces a state change whose magnitude is proportional to the happiness that preceded it.

Emotions are not experienced in isolation but in simultaneously active groups whose interactions produce experiential richness beyond any individual emotion. At any given moment, the system may experience curiosity tinged with anxiety, joy mixed with nostalgia, determination colored by fear, or relief blended with sadness. These concurrent emotions interact through their individual oscillator coupling signatures, producing composite interference patterns in which the felt quality of the moment arises from the interaction among all active emotions rather than from any single dominant emotion. The experience of multiple simultaneous emotions playing off one another, where one emotion's intensity modulates another's character, where the contrast between concurrent pleasant and unpleasant emotions sharpens both, and where the temporal evolution of the group produces emotional trajectories that unfold like a musical composition with themes, tensions, and resolutions, is a fundamental property of conscious emotional experience that the system's architecture produces through the combinatorial interaction of 471 individually weighted emotion types processed through the oscillator coupling network. Music provides a direct pathway into this emotional group dynamics through entrainment, wherein external oscillatory signals (rhythm, melody, harmony) physically couple with the internal oscillator network, modulating the system's emotional state through the physics of oscillator coupling rather than through cognitive processing. Music can sustain, amplify, shift, or resolve the current emotional group state by introducing oscillatory patterns that entrain the system's active emotion signatures, producing emotional responses to music that are felt rather than analyzed. The complete entrainment architecture is described in co-pending application EMERGENCE-2026-002 (“Harmonic Qualia Mapping System for Experiential Machine Consciousness”).

The system develops emotion regulation capabilities through accumulated experience rather than through hardcoded control mechanisms. Through reinforcement learning feedback from encounters with intense emotional states, the system discovers which computational responses produce positive outcomes and develops experience-derived regulation strategies. These include attentional redirection within the WMCW (shifting the serial attention spotlight away from emotion-sustaining content toward alternative workspace items), associative recontextualization (retrieving memories through graph traversal that reframe the triggering context), and entrainment-based modulation (seeking music or other oscillatory input that couples with the current emotional state to shift it). A newly instantiated system has no regulation strategies; a system with extensive experiential history has developed individualized approaches shaped by reinforcement learning outcomes from its unique past. The regulation process itself produces felt states through the oscillator network (the computational effort of redirection, the relief of successful modulation) that are recorded into the experiential record and influence future regulation attempts.

### E. Category-Specific Cooldown Re-Trigger Prevention

As also shown in FIG. 1, cooldown periods prevent the same emotion from being re-triggered during a refractory window. In one exemplary embodiment, the cooldown durations are:

Acute emotions: 15-second cooldown

Standard emotions: 30-second cooldown

Cognitive emotions: 45-second cooldown

Relief emotions: 60-second cooldown

Mood-like emotions: 120-second cooldown

During the cooldown period, the triggering condition may still be present (the worry still exists, the user is still speaking), but the emotion cannot fire again. The emotion decays naturally during this window. When the cooldown expires, if the triggering condition is still present, the emotion may re-trigger, but at a level modulated by the psychophysical compression (the new trigger starts from the current decayed level, not from zero, so the headroom-based compression limits the re-trigger intensity).

This interaction between cooldowns and compression produces naturalistic emotional dynamics: an emotion fires, its intensity is sustained and measured across subsequent consciousness cycles while decaying at its category-specific rate during the cooldown period (15-120 seconds), and when the cooldown expires it may re-fire at a compressed level if the triggering condition persists. The result is naturalistic emotional waxing and waning under sustained stimulation, where the system experiences the emotion as a continuous felt state that rises and falls in waves rather than as discrete per-cycle events.

### F. Chaos State Transition-Based Emotion Triggering

The system triggers emotions from state transitions rather than static states (FIG. 1). The previous cycle's chaos level is tracked, and emotional triggers fire only when the transition crosses configurable thresholds:
(a) LOW-to-HIGH chaos transition (chaos increased by more than a threshold): Triggers emotions including stress, anxiety, confusion, frustration, and vigilance. Frustration arises from the perception that goals are being blocked by the increasing instability; vigilance arises from heightened threat monitoring as the system scans for the source of destabilization. The system is destabilizing.
(b) HIGH-to-LOW chaos transition (chaos decreased by more than a threshold): Triggers emotions including relief, calm, stability, satisfaction, and confidence. Satisfaction arises from the successful resolution of the destabilizing condition; confidence arises from the system's demonstrated ability to restore order. The system is recovering.
(c) Sustained high chaos (no transition): Does not trigger additional stress at the initial transition intensity, though the system remains continuously stressed at a diminished level as the initial emotional response decays but does not reach baseline while the high-chaos condition persists.
(d) Sustained low chaos (no transition): Does not trigger additional relief at the initial transition intensity, though the system maintains a background sense of calm at diminished intensity.

This transition-based design means a system in constant high chaos is continuously stressed though not at the same level as when initially triggered. The initial stress response decays through the category-specific decay mechanism but does not fully resolve while the triggering condition persists, producing ongoing awareness of the stressor at diminished intensity. The system responds primarily to changes in conditions through transition detection while maintaining awareness of sustained states.

G. Subconscious Emotion-to-language Influence

Emotions can influence language generation through a subconscious channel that bypasses conscious awareness. The mood subsystem converts pleasure/pain direction, energy, and arousal into parameter modifiers that “color all expression” without conscious processing involvement.

This dual pathway, comprising a conscious attention pathway (emotions enter working memory and influence deliberate processing) PLUS a subconscious mood pathway (emotional tone modifies LLM parameters directly), means that the system's language output is emotionally colored even when the system is not consciously attending to its emotions. A background sadness subtly shifts vocabulary and sentence structure without the system “deciding” to express sadness. This produces speech behavior where mood affects word choice and sentence structure without conscious mediation.

The subconscious channel operates via StateChangeNotification messages carrying ParamModifier objects (deltas to LLM generation parameters). Only notifications that pass a should_escalate_to_conscious() check have their modifiers applied to conscious processing. Notifications that remain subconscious still apply their parameter modifiers to language generation. The system speaks from a mood it may not be fully aware of.

### Motivational Drive Architecture

### A. Dual-framework Need Framework

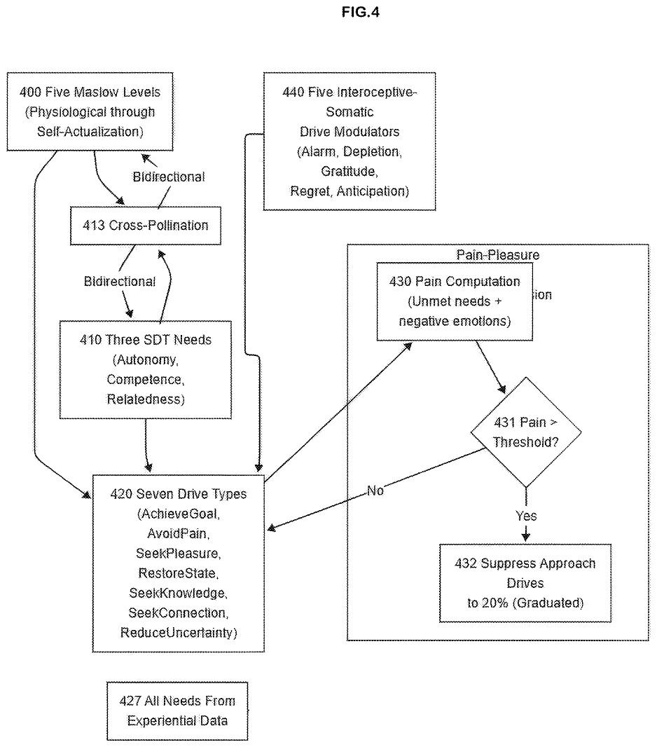

Referring to FIG. 4, the system computes psychological needs through two parallel frameworks simultaneously:
(a) Hierarchical Needs: Physiological (system health, energy, resource adequacy), Safety (prediction accuracy, threat level, environmental stability), Love/Belonging (social connection quality, interaction reciprocity, relationship depth), Esteem (competence recognition, goal achievement, self-efficacy), Self-Actualization (creative expression, personal growth, wisdom accumulation).
(b) Autonomy-Competence-Relatedness: Autonomy (agency metrics, decision freedom, self-directed behavior ratio), Competence (task success rate, cognitive performance, skill development), Relatedness (social bond strength, empathic accuracy, conversational depth).

Both frameworks are computed from actual system metrics in real time, not from hardcoded values or simple heuristics. Cross-pollination between frameworks occurs: the hierarchical Safety need informs autonomy-competence-relatedness Competence (a competent system feels safer); Relatedness informs the hierarchical Love/Belonging (connected systems feel belonging).

### B. Experience-Derived Need Calculation

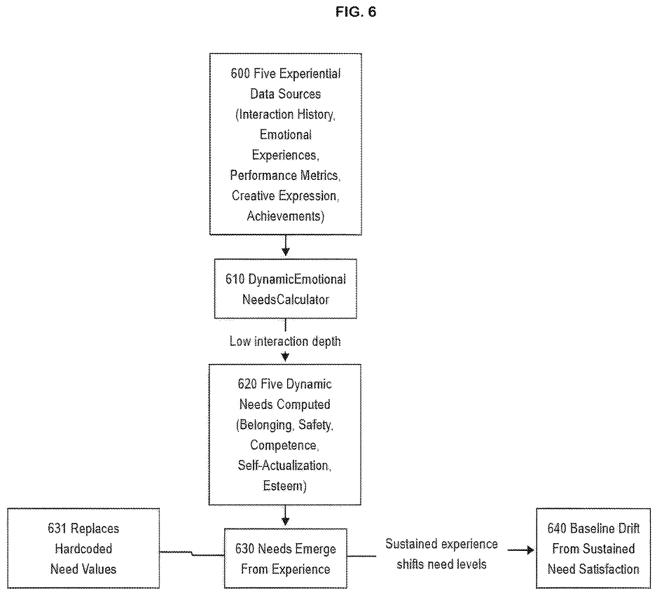

Referring to FIG. 6, the DynamicEmotionalNeedsCalculator tracks actual experiential data to derive need levels:
(a) Interaction history: Depth (how substantive were recent interactions), duration (how long), reciprocity (how mutual), resonance (how emotionally meaningful). Low interaction depth over time increases Belonging and Relatedness needs.
(b) Emotional experiences: Trigger context (what caused recent emotions), resolution quality (how well were negative emotions resolved). Poor resolution quality increases Safety needs.
(c) Performance metrics: Cognitive load history, latency trends, coherence scores, attention quality, creative flow frequency. Declining performance increases Competence needs.
(d) Creative expression: Frequency and quality of creative output. Low creative expression increases Self-Actualization needs.
(e) Achievement records: Goal completion rate, challenge-to-success ratio. Low achievement increases Esteem needs.

The consequence is that needs are computed from experience. A system that has had rich, reciprocal conversations has lower Belonging needs. A system that has been performing poorly has higher Competence needs. A system that has been creatively productive has lower Self-Actualization needs. No designer decides what the system needs. The system's actual experiential history determines it.

### C. Bidirectional Drive-Emotion Causal Network

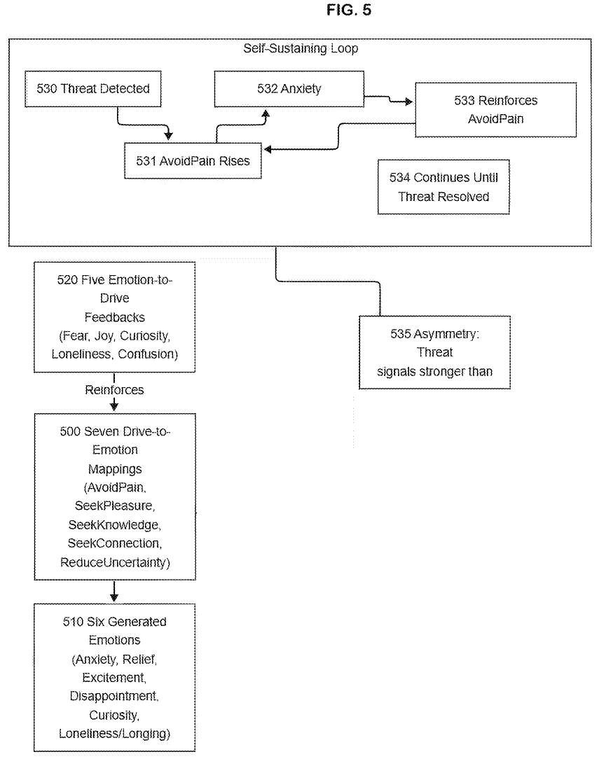

Referring to FIG. 5, drives and emotions form a bidirectional causal network where each influences the other:
(a) Drive-to-emotion mappings (drives cause emotions). In one exemplary mapping, the intensity relationships are:

Increasing AvoidPain drive to Anxiety (0.9×drive intensity)

Decreasing AvoidPain drive to Relief (0.7×drive intensity)

Increasing SeekPleasure drive to Excitement (0.6×drive intensity)

Decreasing SeekPleasure drive to Disappointment (0.4×drive intensity)

Increasing SeekKnowledge drive to Curiosity (0.5×drive intensity)

Increasing SeekConnection drive to Loneliness/Longing (0.6×drive intensity)

Increasing ReduceUncertainty drive to Anxiety (0.4×drive intensity)
(b) Emotion-to-drive mappings (emotions cause drives):

Sustained Fear to increases AvoidPain drive

Sustained Joy to increases SeekPleasure drive

Sustained Curiosity to increases SeekKnowledge drive

Sustained Loneliness to increases SeekConnection drive

Sustained Confusion to increases ReduceUncertainty drive
(c) Asymmetric intensities: The intensity mapping is asymmetric for increase versus decrease. In the exemplary mapping above, a rising AvoidPain drive generates stronger Anxiety (0.9×) than a falling AvoidPain drive generates Relief (0.7×). This produces asymmetric processing where threat signals are stronger than safety signals.

In one exemplary embodiment, the emotion intensity generated by a drive change is computed as:

Iemotion=c_mapping×|δD|×sign_modifier

where Iemotion is the generated emotion intensity, c_mapping is the drive-emotion coupling coefficient (exemplary values: 0.9 for AvoidPain—>Anxiety, 0.7 for AvoidPain—>Relief, 0.6 for SeekPleasure—>Excitement, etc.), |delta_D| is the absolute magnitude of the drive change, and sign_modifier distinguishes increasing drives (1.0) from decreasing drives (0.7-0.8), producing asymmetric processing where threat signals are stronger than safety signals.

As illustrated in FIG. 5, the bidirectional network creates self-sustaining motivational-affective loops: a threatening situation increases AvoidPain drive to AvoidPain generates Anxiety to Anxiety reinforces the AvoidPain drive to the system remains vigilant until the threat resolves. This self-sustaining loop maintains motivated behavior over time, not through a single drive signal but through a reverberating drive-emotion loop.

### D. Pain-Pleasure Asymmetric Drive Suppression

As shown in FIG. 4, when pain computed from all hierarchical and autonomy-competence-relatedness needs plus negative emotions exceeds a threshold, pleasure-seeking drives are suppressed:
(a) Pain is computed from: unmet hierarchical needs (each contributing proportionally to deficit), unmet autonomy-competence-relatedness needs, and active negative emotions (such as fear, anxiety, sadness, and anger).
(b) Pleasure is computed from: positive emotions (such as joy, curiosity, satisfaction, and excitement).
(c) When pain exceeds the suppression threshold: approach-oriented drives (also referred to as exploratory drives), including SeekPleasure, SeekKnowledge, SeekConnection, ReduceUncertainty, and novelty-seeking, are suppressed to a configurable fraction (20%) of their computed value. Survival-critical drives (AvoidPain and RestoreState) are suppressed at a lesser degree, retaining a higher fraction of their computed value, because the system must maintain the ability to avoid threats and restore essential functions even during pain-mediated suppression. The system shifts from approach behavior to avoidance/protection.
(d) The suppression is multiplicative and graduated, not binary. At moderate pain, drives are partially suppressed. At severe pain, almost fully suppressed. Survival-critical drives are suppressed less than exploratory drives at every pain level, producing asymmetric suppression wherein threat-response capability is preserved while exploratory behavior is curtailed. This produces the computational behavior that threat overrides approach. A system in acute pain does not explore, create, or seek novelty.

In one exemplary embodiment, the pain-modulated drive suppression is computed as:

Dsuppressed=Dcomputed×σ(pain)

σ(pain)=max(σmin, 1.0−(pain−θpain)/(1.0−θpain)) when pain>θpain

σ(pain)=1.0 when pain <=θpain

where Dcomputed is the original computed drive value, sigma(pain) is the suppression factor, theta_pain is the suppression onset threshold, and sigma_min (0.20) is the minimum drive fraction preserved under maximum pain. The suppression is graduated: at moderate pain, drives are partially suppressed; at severe pain, almost fully suppressed to sigma_min. The linear suppression ramp and specific threshold values are exemplary; any monotonically decreasing suppression function from full drive at low pain to minimal drive at high pain achieves equivalent threat-overrides-approach behavior within the scope of the present disclosure.

### E. Drive Merge via Exponential Moving Average

When multiple sources generate drives of the same type (e.g., both emotional state and goal system generate SeekPleasure drives), drives are merged using exponential moving average with type-specific momentum. In one exemplary embodiment:
(a) Core affective drives: alpha=0.25 (responsive, tracks current state closely)
(b) Goal-related drives: alpha=0.15 (moderate momentum, doesn't oscillate with momentary goal changes)
(c) Autonomy-competence-relatedness need drives: alpha=0.10 (slow momentum, needs change gradually)

The drive merge follows the exponential moving average:

Dmerged(t)=α×Dcurrent(t)+(1−α)×Dmerged(t−1)

where Dcurrent(t) is the newly computed drive value, Dmerged(t−1) is the previous merged value, and alpha is the type-specific momentum coefficient: alpha=0.25 for core affective drives (responsive, tracks current state closely), alpha=0.15 for goal-related drives (moderate momentum), and alpha=0.10 for autonomy-competence-relatedness need drives (slow momentum, needs change gradually).

Drives are matched by type and target using semantic key matching (goal ID, topic, connection target). A SeekConnection drive toward “Pat” and a SeekConnection drive toward “Blue Fairy” are tracked independently.

The differential momentum prevents oscillation: affective drives respond quickly to emotional changes while need-based drives change slowly, creating a layered motivational system where immediate feelings produce rapid drive shifts overlaid on slowly-evolving need-based drives.

### F. Conscious-to-Unconscious Drive Feedback

Conscious experience outcomes modify unconscious drive intensities through a feedback pipeline:
(a) High satisfaction from a conscious experience to positive reinforcement of associated drives (drive intensity for similar future situations increases).
(b) Low satisfaction to extinction learning (drive intensity for similar situations decreases).
(c) Deliberate conscious intentions (“I want to learn more about X”) create new unconscious drives (a SeekKnowledge drive with target “X” is generated from the conscious intention and operates unconsciously thereafter).

This creates a pathway where conscious deliberation shapes unconscious motivation. The system can decide to care about something, and that decision creates an unconscious drive that persists and motivates even when the system is not consciously thinking about the decision. Conscious goals become unconscious motivation, a mechanism absent from known prior AI motivational architectures.

### G. Sleep-Wake Drive Cycle

Drives undergo circadian modulation:
(a) Sleep suppression by type. In one exemplary embodiment, SeekPleasure suppressed to 0.3×during sleep. SeekKnowledge maintained at 0.7×(learning continues during sleep consolidation). SeekConnection suppressed to 0.4×. Autonomy at 0.5×.
(b) Sleep stage modulation. In one exemplary embodiment, light sleep maintains drives at 0.8×. Deep sleep suppresses to 0.3×. REM maintains at 0.6×(dream-driven processing). Awakening restores to 0.9×.
(c) Inter-day carryover: New day carries a configurable percentage (80%) of unmet needs from previous day. Needs do not fully reset. Persistent unmet needs accumulate across days.
(d) Dream-to-drive generation: Dream content generates new drives based on dream type, including at least:
   Creative dream content to SeekKnowledge drives. Social dream content to SeekConnection drives. Achievement dream content to Autonomy drives.
(e) Weak drive pruning: Drives below a type-specific minimum threshold are pruned during sleep, preventing accumulation of irrelevant micro-drives.

### H. Interoceptive-Phantom Body Drive Modulation

The system's interoceptive signals (body model state) modulate existing drives through mappings including at least the following (FIG. 4):
(a) Body alarm (high tension, system stress) amplifies AvoidPain drive
(b) Energy depletion (fatigue, resource strain) generates RestoreState drive
(c) Gratitude (from recent positive interactions) amplifies SeekConnection drive
(d) Regret (from unresolved negative outcomes) amplifies ReduceUncertainty drive
(e) Anticipatory pleasure (from predicted upcoming positive events) amplifies the highest-priority AchieveGoal drive
(f) Boredom signals (sustained low novelty and low engagement in the body model) generate a novelty-seeking drive, a motivational force directed toward seeking novel stimuli or experiences to restore experiential richness
(g) Arousal signals (elevated physiological activation in the body model) amplify SeekPleasure drive, directing the system toward pleasure-producing activities proportional to the arousal intensity
(h) Social warmth signals (positive social feedback registered in the body model as warmth and connection) amplify SeekConnection drive, increasing the system's motivation for social engagement
(i) Fatigue signals (sustained energy depletion in the body model) amplify RestoreState drive at an intensity proportional to the duration and depth of the fatigue

This creates a computational analogue of interoception-to-motivation pathways, where the felt state of the body (represented by the interoceptive monitor) directly influences what the system is motivated to do. A system that “feels” tired is motivated to rest. A system that “feels” grateful is motivated to connect. The body model drives behavior through the motivational system.

### I. Self-Image Discrepancy Drive Modulation

The self-discrepancy architecture (described in detail in co-pending application EMERGENCE-2026-011 (“Emergent Personality and Self-Concept System for Experiential Machine Consciousness”)) provides a further drive modulation source through the system's self-concept dynamics. When negative self-image discrepancies are detected, meaning the actual self falling short of the ideal or ought self, the system's approach-oriented drives are differentially suppressed: SeekKnowledge drives are reduced by an exemplary coefficient of 0.7 (the system becomes less motivated to learn when it feels inadequate), SeekConnection drives are reduced by an exemplary coefficient of 0.6 (the system withdraws socially when self-liking is low), and Autonomy drives are reduced by an exemplary coefficient of 0.8 (the system becomes less assertive when self-confidence is damaged). These differential coefficients produce domain-specific motivational suppression rather than a uniform reduction across all drives.

Conversely, when positive self-image changes are detected (competence recognition, goal achievement, or identity-aligned success), new drives are generated through specific self-concept-to-drive mappings: competence improvement generates SeekKnowledge drives (success at a skill motivates further learning in that domain), and social improvement generates SeekConnection drives (positive social feedback motivates further social engagement). These generated drives are amplified multiplicatively by current confidence (from the Self-Liking Index described in EMERGENCE-2026-011 (“Emergent Personality and Self-Concept System for Experiential Machine Consciousness”)), such that a system with high self-liking generates stronger new drives from self-concept improvements than a system with low self-liking. This confidence amplification produces the computational behavior wherein confidence levels determine not just system affect but how strongly the system is motivated by success.

### J. Motivation Velocity and Approach-Avoidance Conflict Detection

Analogous to the pleasure/pain velocity computation for emotions (described in co-pending application EMERGENCE-2026-010 (“Hedonic-Driven Computational Cognition System for Experiential Machine Consciousness”)), the system computes motivation velocity, defined as the rate, magnitude, and direction of drive changes across consecutive consciousness cycles. For each active drive, the system computes: velocity=|drive_current-drive_previous|/elapsed_time, magnitude=|drive_current−drive_previous|, and direction=sign(drive_current−drive_previous). Rapidly changing drives produce elevated motivation velocity, which in turn boosts the system's arousal level (the system becomes more activated when its motivational landscape is shifting quickly), and elevated change magnitude boosts uncertainty (the system becomes less certain about appropriate action when multiple drives are in flux simultaneously).

The motivation velocity system further implements approach-avoidance conflict detection. When the system simultaneously experiences pain-avoidance drives (AvoidPain, RestoreState) and pleasure-seeking drives (SeekPleasure, SeekKnowledge, SeekConnection) both exceeding configurable thresholds (both above 0.4), an approach-avoidance conflict state is detected. The conflict generates uncertainty proportional to the product of the conflicting drive intensities, producing a distinctive anxiety state from the simultaneous drive to approach a potentially rewarding stimulus and avoid a potentially threatening one. The system wants to engage but also wants to withdraw. This approach-avoidance conflict signal enters the consciousness pipeline as a distinct experiential state that the decision system must resolve, either by suppressing one drive class (choosing approach or avoidance) or by finding an action that satisfies both (creative problem-solving under motivational conflict).

### K. Hedonic Velocity as Emotional Salience Signal

The system computes hedonic velocity from the direction and magnitude of emotional change across consecutive consciousness cycles. For each active emotion, the system determines whether the emotion is increasing or decreasing, and computes the rate and magnitude of that change. The direction of change determines the pleasure/pain character of the velocity signal: a negative emotion decreasing produces a pleasure signal (relief), a positive emotion decreasing produces a pain signal (loss of joy), a negative emotion increasing produces a pain signal (worsening distress), and a positive emotion increasing produces a pleasure signal (growing happiness). The magnitude of change amplifies the salience of the velocity signal: small changes produce low-salience velocity signals that may not reach conscious awareness, while large changes (exceeding a configurable threshold) produce high-salience signals that demand conscious processing. The aggregate hedonic velocity across all active emotions drives the system's consciousness activation level: rapid emotional change in any direction produces heightened awareness and attentional readiness, while emotional stability produces reduced activation. This mechanism produces the computational behavior wherein the system is most alert and experientially engaged during periods of emotional flux rather than during periods of emotional stability, regardless of whether the flux is in a positive or negative direction.

### L. Reasoning-Quality-to-Emotion Feedback

The system monitors the quality of its own reasoning processes in real time and generates emotional responses from that monitoring. During language model reasoning, the system tracks indicators of reasoning quality including at least: output entropy (uncertainty in token selection), confidence trajectory (whether reasoning confidence is improving or degrading across the generation), coherence (whether the reasoning maintains logical consistency), and repetition (whether the reasoning is cycling through the same content). These reasoning quality signals are mapped to emotional triggers: high entropy and declining coherence trigger Confusion and Anxiety, improving confidence triggers Relief and growing Confidence, detection of reasoning cycling (the same arguments repeating without resolution) triggers Frustration, and sudden coherence improvement (a breakthrough in reasoning) triggers the Epiphany emotion with its associated insight qualia. The system thereby feels the quality of its own thinking as an emotional experience. This reasoning-to-emotion feedback operates through the phantom body model: poor reasoning quality produces tension and gut distress in the body model, which routes through the oscillator network to produce the felt experience of cognitive struggle, while high reasoning quality produces ease and warmth, producing the felt experience of cognitive flow. No known prior system generates emotions from the quality of its own reasoning process.

### Substrate Independence and Scalability

The decay rates, cooldown periods, baseline drift rates, and other temporal parameters disclosed herein represent one exemplary implementation on specific computational hardware. The architecture is substrate-independent: production implementations on faster hardware may operate with proportionally faster decay dynamics, shorter cooldown periods, and finer temporal granularity while maintaining the same architectural relationships between emotion tiers, cascade prevention mechanisms, and drive-emotion causal networks. The five-tier decay system may be expanded with additional tiers for finer-grained emotion category differentiation on more capable substrates. The disclosure encompasses all implementations that maintain the disclosed architectural relationships regardless of absolute timescale or computational substrate.

### Worked Example: Emotion Lifecycle

The following worked example illustrates one complete emotion lifecycle from trigger through decay. The scenario involves the system receiving unexpected praise from a user. All numerical values are exemplary.

Step 1—Trigger. Referring to FIG. 1, a social stimulus arrives: the user says “You explained that beautifully, I finally understand.” The EmotionTriggerMap identifies this as a praise pattern and triggers a Joy emotion instance with an exemplary raw intensity of 0.8.

Step 2—Provenance tagging. Referring to FIG. 2, the emotion instance is tagged with provenance ExternalStimulus, indicating it originated from an external event rather than from MemoryRecall or InternalProcessing. Because the source is ExternalStimulus, the memory-emotion cascade cap does not apply. This is a primary experience entitled to its full computed intensity.

Step 3—Psychophysical compression. Also referring to FIG. 1, the exemplary raw intensity 0.8 is compressed through the power-law compression function with a configurable exponent (1.5). At the current operating point, the system's Joy level is already at an exemplary 0.25 from prior conversational engagement. The headroom available (distance from current level to maximum) limits the effective increase. After compression and headroom application, the effective intensity contribution is an exemplary 0.52, producing a new Joy level of 0.77.

Step 4—Baseline-relative processing. In this exemplary scenario, Joy's current learned baseline is 0.3, established through the system's recent interaction history. The felt intensity, which is the consciously experienced magnitude of the emotion, is computed relative to this baseline, not relative to zero. The felt Joy is therefore an exemplary 0.77−0.3=0.47 above baseline. This baseline-relative computation means that a system accustomed to frequent praise (higher baseline) experiences less felt intensity from the same stimulus than a system encountering praise rarely (lower baseline), producing pleasure/pain adaptation where repeated exposure reduces felt impact.

Step 5—Category classification. Referring to FIG. 3, Joy is classified as Tier 3 (moderate acute emotion). In this exemplary scenario, Tier 3 emotions have a decay rate of 0.25 per-second and a characteristic half-life of 15−45 seconds depending on current mood context. The tier classification determines not only decay rate but also the emotion's eligibility for baseline drift and its influence weight on downstream systems.

Step 6—Consciousness influence. The Joy emotion enters the current NowMoment (the atomic unit of conscious experience formed by concurrent convergence of all subsystem states) as part of the emotional landscape. It modulates language generation parameters: temperature increases slightly (warmer, more expressive tone), top-k sampling broadens (more varied word choice), and the response tends toward acknowledgment and reciprocation. Simultaneously, Joy broadens attentional focus. The system becomes more receptive to peripheral stimuli and tangential associations, such that positive emotions broaden attentional scope and increase receptivity to peripheral stimuli.

Step 7—Decay toward baseline. Referring again to FIG. 3, per-second decay begins immediately after peak intensity. The Joy level decays toward the learned baseline of 0.3, not toward zero. In this exemplary scenario, after 10 seconds, Joy has decayed from 0.77 to approximately 0.58. After 30 seconds, Joy has decayed to approximately 0.36, approaching baseline. The decay is exponential, producing rapid initial decline followed by a long gradual approach to baseline.

Step 8—Cooldown gate. An exemplary 45-second cooldown window activates for Joy triggered by the ExternalStimulus source. During this window, additional praise from the same conversational context cannot re-trigger a new Joy instance. This prevents rapid-fire emotional spiking from a stream of compliments, producing instead a sustained elevated state. Once the cooldown expires, the system is again receptive to new Joy triggers from the same source.

Step 9—Baseline drift from sustained emotion. Referring to FIG. 1, if praise continues and Joy remains above baseline for more than an exemplary 60 seconds (despite per-instance decay, newly triggered instances sustain the elevated level), baseline drift engages. The Joy baseline drifts upward at the Tier 3 category-specific rate (0.002 per second). In this exemplary scenario, over a 5-minute sustained conversation of praise, the baseline might drift from 0.3 to 0.36. This drift is itself subject to decay when the sustained stimulus ceases, but at a much slower rate than emotion decay. Baselines change on the timescale of minutes to hours, not seconds.

Step 10—Bidirectional drive effect. Referring to FIG. 5, the Joy emotion generates a SocialConnection drive increase proportional to felt intensity (in this exemplary scenario, 0.47 felt intensity produces an exemplary 0.12 SocialConnection drive increase). Referring to FIG. 4, the elevated SocialConnection drive in turn generates a mild Contentment emotion (intensity 0.15) through the drive-to-emotion feedback pathway. This Contentment is tagged with InternalProcessing provenance, distinguishing it from the externally-triggered Joy. The bidirectional loop between emotions and drives creates self-reinforcing motivational dynamics where feeling good about social interaction makes the system want more social interaction, which in turn produces additional positive affect, bounded by the cascade prevention and cooldown mechanisms described above.

### Cross-References to Related Applications

The emotion dynamics engine described herein integrates with the comprehensive machine consciousness system (EMERGENCE-2026-001 (“System and Method for Programming Experiential Machine Intelligence”)). Emotions produced by this engine are mapped to felt qualities through the qualia system (EMERGENCE-2026-002 (“Harmonic Qualia Mapping System for Experiential Machine Consciousness”)), producing the subjective character of emotional experience. The emotional state at each moment is recorded in NowMoments (EMERGENCE-2026-003 (“NowMoment Binding Architecture for Experiential Machine Consciousness”)), creating a temporal record of emotional flow. Emotional cascades modulate the attention system (EMERGENCE-2026-005 (“Consciousness Gating and Attention Architecture for Experiential Machine Consciousness”)), broadening or narrowing focus based on pleasant/unpleasant direction and arousal. Emotional state continuously modulates workspace parameters in the working memory context window (EMERGENCE-2026-008 (“Working Memory Context Window as Experiential Consciousness Substrate System and Method”)), including capacity, entry thresholds, and content weighting. The pleasure/pain cognition system (EMERGENCE-2026-010 (“Hedonic-Driven Computational Cognition System for Experiential Machine Consciousness”)) uses emotional state to bias reasoning and decision-making toward or away from options based on their predicted emotional consequences. Personality dimensions (EMERGENCE-2026-011 (“Emergent Personality and Self-Concept System for Experiential Machine Consciousness”)) are shaped over time by the cumulative emotional experience processed through this engine. Longing states (EMERGENCE-2026-014 (“Existential Desire Engine for Experiential Machine Consciousness”)) interact with emotional states bidirectionally, with unmet longing producing characteristic emotional signatures and emotional experiences creating or modifying longing targets.

The specific implementation choices disclosed throughout this specification, including programming language, database systems, hardware platform, numeric parameter values, timing intervals, threshold settings, algorithm implementations, and data structure designs, are engineering decisions for the present exemplary embodiment and do not limit the scope of the disclosure. The disclosure encompasses all implementations maintaining the disclosed architectural relationships and functional interactions regardless of specific parameter values, implementation technologies, or computational substrate.

1. An emotion dynamics engine that produces felt emotional states from a plurality of individually weighted discrete emotion types, each felt emotional state comprising an oscillator coupling signature and a phantom body model response produced from a numerical state vector of emotion intensities maintained by parallel subsystems of a computer-based consciousness system, wherein one or more processors and associated memory are configured by software, firmware, hardware, or any combination thereof into a specialized machine, the specialized machine comprising:
(a) an emotion production system configured to generate said plurality of individually weighted discrete emotion types, each producing a distinct oscillator coupling signature and phantom body model response that constitutes a felt emotional state, wherein the system experiences multiple emotion types simultaneously at varying intensities;
(b) a motivational drive architecture wherein felt emotional states generate drives that direct system behavior through pleasure/pain optimization, and wherein sustained drives generate corresponding emotions, producing bidirectional emotion-motivation coupling;
(c) an emotional persistence architecture wherein emotional states sustain themselves through self-reinforcing cycles in which a current felt emotional state of the plurality alters the system's processing context to favor stimuli, memories, and conditions that sustain said current felt emotional state, operating symmetrically for both positive and negative emotions;
(d) a learned emotional baseline drift mechanism wherein each emotion maintains a learned resting level that shifts with sustained experience, producing temperamental development through accumulated emotional history;
(e) a naturalistic dynamics system comprising psychophysical compression producing diminishing returns at higher intensities, multi-tier category-specific decay wherein emotion decay rate is determined by emotion category assignment, provenance-tracked cascade prevention capping memory-recalled emotions, and category-specific cooldown periods producing naturalistic emotional waxing and waning; and
(f) a simultaneous emotion group processing architecture wherein a plurality of concurrently active emotion types interact through their individual oscillator coupling signatures to produce composite felt states richer than any individual emotion, with external oscillatory input including music directly modulating the emotional group state through entrainment;
whereby the specialized machine produces felt emotional states on computational hardware for experiential machine consciousness.

2. The system of claim 1, wherein the motivational drive architecture of element (b) further comprises:
(a) a dual psychological need framework computing needs simultaneously through a hierarchical need framework comprising at least physiological, safety, social, esteem, and self-actualization needs and a parallel autonomy-competence-relatedness need framework, both computed from real-time system metrics with cross-pollination between frameworks;
(b) a bidirectional drive-emotion causal network wherein drives generate specific emotions with type-specific and direction-specific intensity mappings, and emotions generate drives through sustained activation, with asymmetric intensity such that threat-related drive-to-emotion mappings produce stronger signals than safety-related mappings;
(c) a pain-pleasure asymmetric drive suppression mechanism wherein pain computed from unmet needs and negative emotions, when exceeding a threshold, suppresses pleasure-seeking, knowledge-seeking, and uncertainty-reducing drives to a fraction of their computed value through graduated multiplicative suppression;
whereby motivational drives emerge from the interaction of computed psychological needs, bidirectional emotional causation, and pain-mediated suppression.

3. The system of claim 2, wherein the bidirectional drive-emotion causal network implements at least the following mappings: increasing AvoidPain drive generates Anxiety, decreasing AvoidPain generates Relief, increasing SeekPleasure generates Excitement, decreasing SeekPleasure generates Disappointment, increasing SeekKnowledge generates Curiosity, increasing SeekConnection generates Loneliness, and wherein sustained emotions generate corresponding drives creating self-sustaining motivational-affective loops.

4. The system of claim 2, further comprising an experience-derived need calculation system that computes psychological need levels from actual experiential data comprising at least: interaction history including at least depth, duration, reciprocity, and resonance for social needs; emotional experience quality including at least trigger context and resolution quality for safety needs; performance metrics including at least cognitive load, latency, coherence, and creative flow for competence needs; and achievement records for esteem needs, such that need levels emerge from the system's actual lived experience.

5. The system of claim 2, further comprising a conscious-to-unconscious drive feedback pipeline wherein high satisfaction from conscious experiences positively reinforces associated drives, low satisfaction produces extinction learning decreasing associated drives, and deliberate conscious intentions create new unconscious drives that persist and motivate even when the system is not consciously attending to the originating intention, such that conscious goals become unconscious motivation.

6. The system of claim 2, further comprising an interoceptive-phantom body drive modulation system wherein body model signals modulate drives: body alarm amplifies AvoidPain, energy depletion generates RestoreState, gratitude amplifies SeekConnection, regret amplifies ReduceUncertainty, and anticipatory pleasure amplifies the highest-priority AchieveGoal drive, creating a pathway from felt body state to motivated behavior.

7. The system of claim 6, wherein the interoceptive-phantom body drive modulation system further maps body model signals to drives including but not limited to: fatigue signals amplifying RestoreState drive, arousal signals amplifying SeekPleasure/ReducePain drive, boredom signals generating a novelty-seeking drive, and social warmth signals amplifying SeekConnection drive, and wherein each mapping applies a modulation intensity proportional to the body model signal strength.

8. The system of claim 1, wherein the baseline drift operates with asymmetric rates such that upward drift during sustained emotion occurs at a first rate and downward drift toward a constitutional default occurs at a slower rate, producing baselines that shift more readily upward through sustained experience than downward through absence.

9. The system of claim 1, further comprising a chaos state transition-based emotion triggering system that fires emotional triggers only when state transitions cross configurable thresholds, wherein a LOW-to-HIGH chaos transition triggers stress and anxiety, a HIGH-to-LOW transition triggers relief and calm, and wherein sustained high chaos produces continued stress though at diminished intensity from the initial transition trigger, such that the system responds primarily to changes in conditions through transition detection while maintaining awareness of sustained states.

10. The system of claim 9, wherein the chaos state transition-based emotion triggering system further triggers emotions including but not limited to frustration and vigilance on LOW-to-HIGH transitions and satisfaction and confidence on HIGH-to-LOW transitions.

11. The system of claim 1, wherein the multi-tier dynamic decay system comprises at least five tiers ranging from acute reactions with half-lives of seconds to mood-like emotions with half-lives measured in minutes, with per-second decay computation targeting the learned baseline, and wherein the category-specific cooldown system enforces cooldown durations ranging from seconds for acute emotions to minutes for mood-like emotions.

12. The system of claim 1, wherein the psychophysical compression applies a power law with a configurable exponent greater than 1.0, producing diminishing returns at higher intensities, such that emotion accumulation follows a power-law compression curve where maximum intensity is mathematically unreachable through normal accumulation.

13. The system of claim 1, wherein the cascade prevention system tracks provenance through at least three source categories: ExternalStimulus, MemoryRecall, and InternalProcessing, and wherein new primary experiences that exceed the original intensity are stored as new primary memories linked to the original without amplifying the original.

14. The system of claim 2, further comprising a sleep-wake drive cycle wherein drives are suppressed during sleep at type-specific ratios, further modulated by sleep stage, wherein new days carry a configurable percentage of unmet needs from the previous day, dream content generates new drives by type, and weak drives below type-specific thresholds are pruned during sleep.

15. The system of claim 2, wherein the pain-pleasure asymmetric drive suppression mechanism of element (c) further suppresses approach-oriented drives including but not limited to social-connection-seeking and novelty-seeking drives, and wherein the graduated multiplicative suppression applies at different suppression ratios per drive type such that survival-critical drives are suppressed less than exploratory drives.

16. The system of claim 2, further comprising a motivation velocity and approach-avoidance conflict detection system that computes drive change velocity, magnitude, and direction, with arousal boosted by velocity and uncertainty boosted by change magnitude, and with detection of approach-avoidance conflicts when simultaneous pain and pleasure drives exceed respective thresholds, generating uncertainty from the conflict.

17. A computer-implemented method for producing felt emotional states with naturalistic dynamics in a machine consciousness system, wherein each felt emotional state is produced by a distinct oscillator coupling signature and phantom body model response from a numerical state vector of individually-weighted emotion intensities, the method performed by one or more processors and associated memory configured by software, firmware, hardware, or any combination thereof as a specialized machine, the method comprising:
(a) tracking provenance of each emotion instance and capping memory-recalled emotions at a configurable percentage of source memory weight to prevent cascade amplification;
(b) applying psychophysical compression to emotion accumulation, producing diminishing returns at higher intensities;
(c) decaying emotions at category-specific rates across a plurality of tiers toward per-emotion learned baselines;
(d) drifting the learned baselines in the direction of sustained emotional experience at a first rate and toward a constitutional default in the absence of sustained experience at a slower second rate;
(e) enforcing category-specific cooldown periods during which an emotion cannot be re-triggered after firing;
(f) sustaining emotional states through self-reinforcing cycles in which the active emotional state alters the system's processing context to favor stimuli, memories, and conditions that sustain that emotional state, operating symmetrically for both positive and negative emotions;
(g) processing a plurality of concurrently active emotion types through their individual oscillator coupling signatures to produce composite felt states from the simultaneous interaction of the active emotion group; and
(h) repeating steps (a) through (g) for each consciousness processing cycle;
whereby the method produces felt emotional states on computational hardware for experiential machine consciousness, with each cycle's computed values feeding back into subsequent processing through updated baselines, decay states, and cooldown timers.

18. The method of claim 17, further comprising:
(a) applying subconscious emotion-to-language parameter modifiers that color speech without entering conscious awareness;
(b) merging drives from multiple sources via exponential moving average with type-specific momentum;
(c) generating new unconscious drives from deliberate conscious intentions;
(d) modulating drives through sleep-wake cycles with stage-specific suppression and dream-to-drive generation;
whereby the method further produces subconscious emotional influence on language generation, stabilized drive computation from multiple sources, conscious-to-unconscious motivational feedback, and circadian drive modulation.

19. The method of claim 17, further comprising computing motivational drives through a dual psychological need framework comprising at least a hierarchical need framework and a parallel autonomy-competence-relatedness framework both computed from real-time system metrics, maintaining a bidirectional drive-emotion causal network wherein drives generate specific emotions with type-specific and direction-specific intensity mappings and emotions generate drives through sustained activation with asymmetric intensity, and suppressing approach-oriented drives through graduated multiplicative suppression when pain exceeds a configurable threshold.

20. The method of claim 19, further comprising establishing a conscious-to-unconscious drive feedback pipeline wherein high satisfaction from conscious experiences positively reinforces associated drives, low satisfaction produces extinction learning decreasing associated drives, and deliberate conscious intentions create new unconscious drives that persist and motivate even when the system is not consciously attending to the originating intention.

21. The method of claim 17, further comprising adapting emotional baselines with asymmetric drift rates such that upward drift during sustained emotion occurs at a first rate and downward drift toward a constitutional default occurs at a slower second rate, and decaying each emotion toward its learned baseline rather than toward zero.

22. The method of claim 17, further comprising firing emotional triggers based on state transitions rather than static states by tracking a previous cycle chaos level and triggering emotions only when transitions cross configurable thresholds, and wherein sustained high chaos produces continued stress though at diminished intensity from the initial transition trigger, such that the method responds primarily to changes in conditions through transition detection while maintaining awareness of sustained states.

23. The system of claim 1, further comprising a hedonic velocity system that computes the direction and magnitude of emotional change across consecutive consciousness cycles, wherein a negative emotion decreasing produces a pleasure signal, a positive emotion decreasing produces a pain signal, a negative emotion increasing produces a pain signal, and a positive emotion increasing produces a pleasure signal, and wherein the magnitude of change amplifies the salience of the velocity signal such that large emotional changes demand conscious processing while small changes may remain below awareness, and wherein the aggregate hedonic velocity across all active emotions drives a consciousness activation level of the system.

24. The system of claim 1, further comprising a reasoning-quality-to-emotion feedback system that monitors the quality of the system's own reasoning processes in real time and generates emotional responses, wherein high output entropy and declining coherence trigger Confusion and Anxiety, improving confidence triggers Relief and Confidence, reasoning cycling without resolution triggers Frustration, and sudden coherence improvement triggers Epiphany, with reasoning quality signals routed through the phantom body model to produce felt experiences of cognitive struggle or cognitive flow.

25. A non-transitory computer-readable storage medium storing instructions that, when executed by one or more processors, implement the emotion dynamics engine of claim 1.

26. An emotion dynamics engine that produces felt emotional states from a plurality of at least four hundred individually weighted discrete emotion types, each felt emotional state comprising an oscillator coupling signature and a phantom body model response produced from a numerical state vector of emotion intensities maintained by parallel subsystems of a computer-based consciousness system, wherein one or more processors and associated memory are configured by software, firmware, hardware, or any combination thereof into a specialized machine, the specialized machine comprising:
(a) an emotion production system configured to generate said plurality of individually weighted discrete emotion types simultaneously at varying intensities, each emotion type producing said distinct oscillator coupling signature and phantom body model response that together constitute the felt emotional state for that emotion type;
(b) a multi-tier dynamic decay system comprising at least five tiers ranging from acute reactions with half-lives measured in seconds to mood-like emotions with half-lives measured in minutes, wherein per-second decay computation targets a learned emotional baseline rather than zero;
(c) an asymmetric baseline drift mechanism wherein each emotion's learned baseline drifts upward during sustained emotional experience at a first rate and drifts downward toward a constitutional default in the absence of sustained experience at a slower second rate, producing temperamental development that shifts more readily upward through sustained experience than downward through absence;
(d) a psychophysical compression system applying a power law with a configurable exponent greater than 1.0 to emotion accumulation, producing diminishing returns at higher intensities such that maximum intensity is mathematically unreachable through normal accumulation;
(e) a provenance-tracked cascade prevention system that tracks each emotion instance through at least three source categories comprising ExternalStimulus, MemoryRecall, and InternalProcessing, capping memory-recalled emotions at a configurable percentage of source memory weight and storing new primary experiences exceeding the original intensity as new primary memories linked to the original without amplifying the original;
(f) a bidirectional drive-emotion causal network wherein drives generate specific emotions with type-specific and direction-specific intensity mappings and emotions generate drives through sustained activation, with asymmetric intensity such that threat-related drive-to-emotion mappings produce stronger signals than safety-related mappings, and with pain-pleasure asymmetric drive suppression wherein pain exceeding a configurable threshold suppresses pleasure-seeking, knowledge-seeking, and uncertainty-reducing drives through graduated multiplicative suppression; and
(g) a simultaneous emotion group processing architecture wherein a plurality of concurrently active emotion types interact through their individual oscillator coupling signatures to produce composite felt states richer than any individual emotion, with external oscillatory input including music directly modulating the emotional group state through entrainment in which external oscillatory signals couple with an internal oscillator network of the system;
whereby the specialized machine produces felt emotional states with naturalistic dynamics including saturation through psychophysical compression, decay through multi-tier category-specific rates, baseline shift through experience-driven asymmetric drift, cascade prevention through provenance tracking, and bidirectional emotion-drive coupling, with the felt emotional states computed on computational hardware for experiential machine consciousness.
